(19) United States
(12) Patent Application Publication
(10) Pub. No.: US 2012/0107428 A1
(43) Pub. Date: May 3, 2012

(54) REPELLENTS FOR PESTIFEROUS SOCIAL WASPS

(75) Inventors: Rodney G. Schneidmiller, Greenacres, WA (US); Qing-He Zhang, Spokane Valley, WA (US); Doreen R. Hoover, Spokane, WA (US)

(73) Assignee: Sterling International Inc., Spokane, WA (US)

(21) Appl. No.: 13/206,244

(22) Filed: Aug. 9, 2011

Related U.S. Application Data
(60) Provisional application No. 61/477,521, filed on Apr. 20, 2011.
(60) Provisional application No. 61/372,338, filed on Aug. 10, 2010.

(51) Int. Cl. A01N 65/08; A01N 65/44; A01N 65/28; A01N 35/06; A01P 17/00; A01N 65/10; A01N 31/16; A01N 37/10; A01N 37/40; A01N 31/02; A01N 65/22; A01N 65/12

(52) U.S. Cl. 424/742; 424/745; 424/750; 424/769; 424/748; 424/725; 514/692; 424/764; 424/746; 424/776; 514/690; 514/720; 514/691; 514/544; 514/159; 514/724; 514/546

(57) ABSTRACT

Provided herein are essential oils and synthetic compounds, and combinations thereof, as repellent compositions for repelling insects, such as vespid social wasps (Vespidae), including yellowjackets, paper wasps, and hornets. Controlled release devices comprising these repellent compositions are also provided.

### CROSS-REFERENCES TO RELATED APPLICATIONS

This application claims the benefit of U.S. Provisional Application No. 61/372,338, filed Aug. 10, 2010, and also claims the benefit of U.S. Provisional Application No. 61/477,521, filed Apr. 20, 2011, each of which is fully incorporated herein expressly by reference.

### BACKGROUND

Eusocial vespid wasps include several subfamilies, such as Polistinae, Vespinae, and Polybiinae from Vespidae (Hymenoptera: Vespidae), commonly referred to as paper wasps, yellowjackets, and hornets in North America. Ecologically speaking, paper wasps, yellowjackets, and hornets are beneficial insects because they prey upon many pest insects that feed on agricultural crops, garden plants, and forests, especially during early and mid summer season. However, these social wasps can be a serious stinging hazard to humans and animals, particularly in defense of their colonies; but some species from the genera Vespula Thomson and Dolichovespula Rohwer come into frequent contact with people when scavenging for sugar-rich foods and animal carrion away from their nests. In recent years, paper wasps have caused serious problems in fruit orchards and vineyards by biting the fruit and causing scarring, which results in price devaluation and high populations of paper wasps pose a significant danger to harvesters.

Research efforts to develop control or management strategies for these pestiferous social wasps have focused on poison baits to reduce or eliminate wasps and larvae in the nests or on chemical attractants or food materials for traps to reduce foraging adult wasp populations (workers or queens). Combinations of pesticides and meats have been used to control the western yellowjacket, Vespula pensylvanica; the common yellowjacket, Vespula vulgaris (L.); and the German yellowjacket Vespula germanica (F.). Although protein-based poison baits showed some regional success, they are not extensively used because of their expense, the short length of time that they are attractive, and significant side-effects on the non-target species and environment. Moreover, there is only one yellowjacket poison-bait product, Alpine Onslaught® Microencapsulated Esfenvalerate, registered in the USA. On the other hand, chemical attractants, including heptyl butyrate and acetic acid plus isobutanol among others, which are useful in trapping and monitoring vespid wasps, have been reported in several patents and scientific publications. Commercial traps baited with these synthetic attractants have been promoted and used for years as effective tools for monitoring or controlling the vespid wasps.

In contrast to the intensive work and significant progress on the attractants and poison-baits, which target wasp population reduction (an indirect protection measure), little or no research effort has been made on developing direct protection tactics, namely, wasp repellents. U.S. Pat. No. 7,744,280 discloses a wasp repellent device (a polypropylene bag) mimicking the aerial yellowjacket/hornet nest that reportedly repels hornets or yellowjackets. Unfortunately, neither the patents nor the academic literature appear to provide any bioassay data or scientific evidence to support these claims. In fact, most of the yellowjacket species in North America build their nests underground and the few species that build their nests aerially, such as Dolichovespula arenaria, D. maculata, and D. norvegicoides plus Vespa crabro, normally hide them in the tree branches, tree holes, or under or behind some human-made structures. These nesting behaviors raise strong doubts on the visual repellency effect of artificial nests. U.S. Patent Application Publication No. 2008/0305125 reports a series of complex chemical compositions/formulations for topical cosmetic use as wasp repellents that include one or more of 3-(N-n-butyl-N-acetylamino)propionate, dihydronepetalactone, and extract of catmint, and at least one compound selected from certain perfume ingredients (>60 chemicals or oils). Unfortunately, the application does not describe testing the repellency of the exemplified gel formulation (consisting of more than 15 ingredients) alone; instead, the application describes testing the feeding detergency of a combination of the gel formulation with a known mosquito repellent, 15% IR 3535, in comparison with two commercial mosquito repellents, mosquito spray (p-Menta-3,8-diol) and Autan Active Spray (with 20% Icaridin), and a blank control. Since 15% IR 3535 alone was not tested in the bioassay experiment, one could not determine if the 2-min repellency (or feeding deterrency) effect on Vespula vulgaris caused by the binary combination was due to the behavioral activity of the gel formulation or 15% IR 3535 or the combination. Assuming the gel formulation was responsible for the observed wasp repellency (or feeding deterrence), it is still unknown which individual chemical(s) or partial mixtures or full blend of the more than 15 ingredients in this formulation were responsible for the repellent effect. Many of the chemicals on the disclosed “kitchen sink” list probably have no repellency effect at all. In fact, some of the chemicals on the list, such as linalool, benzyl alcohol, and terpineol have been reported as part of a wasp attractant system. To the best of the inventors' knowledge, there are no conclusively confirmed spatial repellents for any pestiferous vespid wasps so far.

### SUMMARY

Methods for controlling insects are disclosed. In some embodiments, a method for repelling an insect comprises: releasing into a space a repellent composition comprising at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones (that is, a mixture of α-thujone and β-thujone), methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil, wherein the repellent composition is comprised in a controlled release device having at least one aperture configured to achieve a desired rate of release of the repellent composition in a volatilized state into the space; and repelling from the space an insect belonging to the insect family Vespidae, wherein each essential oil of (a) or (b) acts to repel the insect. A mixture may exclude any one or more of these oils.

Another method for repelling insects comprises releasing into a space a repellent composition comprising at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof; wherein the repellent composition is comprised in a controlled release device having at least one aperture configured to achieve a desired rate of release of the repellent composition in a volatilized state into the space; and repelling from the space an insect belonging to the insect family Vespidae, wherein each synthetic compound acts to repel the insect. A mixture may exclude any one or more of these compounds.

In the methods disclosed above, the methods may further include releasing into the space any other essential oil(s), not included in the first embodiment but containing any identified repellent compounds disclosed in the second embodiment as major constituent(s).

In the embodiments disclosed above, the formulated repellent essential oils or synthetic compounds can be applied on or in the vicinity of a human or another animal, on or in the vicinity of any properties or structures, or during human activities (events) to repel or deter the target insects.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a bar graph illustrating mean numbers of Vespula pensylvanica workers that landed or approached the attractant source (heptyl butyrate) with repellent candidate essential oil mixture (3EO-mix) deployed at 0 cm or 50 cm above the attractant on a September day in Spokane, Wash. [bars with the same letter within each category were not statistically different (P>0.05) by Duncan's multiple-range test after ANOVA on log (X+1) transformed data];

FIG. 2 is an illustration of simultaneously recorded GC-flame ionization detector (FID) and electroantennographic detector (EAD) (GC-EAD) responses of Western yellowjacket (V. pensylvanica), bald-faced hornet (D. maculata), and European paper wasp (P. dominulus) worker antennae to a Solid-Phase Micro-Extraction (SPME) sample of lemongrass essential oil (CAR/PDMS sampling of 1.0 g essential oil in 20 ml glass vial for 20 sec);

FIG. 3 is an illustration of GC-EAD responses of Western yellowjacket and European paper wasp worker antennae to a SPME sample of rosemary essential oil (CAR/PDMS sampling of 1.0 g essential oil in 20 ml glass vial for 20 sec);

FIG. 4 is an illustration of GC-EAD responses of Western yellowjacket and European paper wasp worker antennae to a SPME sample of clove essential oil (CAR/PDMS sampling of 1.0 g essential oil in 20 ml glass vial for 20 sec);

FIG. 5 is an illustration of GC-EAD responses of Western yellowjacket, European paper wasp, and Golden paper wasp worker (P. aurifer) antennae to a SPME sample of geranium essential oil (CAR/PDMS sampling of 1.0 g essential oil in 20 ml glass vial for 20 sec);

FIG. 6 is an illustration of GC-EAD responses of Western yellowjacket and European paper wasp worker antennae to a SPME sample of ylang ylang essential oil (CAR/PDMS sampling of 1.0 g essential oil in 20 ml glass vial for 20 sec);

FIG. 7 is an illustration of GC-EAD responses of Western yellowjacket and European paper wasp worker antennae to a SPME sample of lavender essential oil (CAR/PDMS sampling of 1.0 g essential oil in 20 ml glass vial for 20 sec);

FIG. 8 is an illustration of GC-EAD responses of Western yellowjacket, bald-faced hornet, and Golden paper wasp worker antennae to a SPME sample of spearmint essential oil (CAR/PDMS sampling of 1.0 g essential oil in 20 ml glass vial for 20 sec);

FIG. 9 is an illustration of GC-EAD responses of Western yellowjacket, bald-faced hornet, and European paper wasp worker antennae to a SPME sample of pennyroyal essential oil (CAR/PDMS sampling of 1.0 g essential oil in 20 ml glass vial for 20 sec);

FIG. 10 is an illustration of GC-EAD responses of Western yellowjacket and European paper wasp worker antennae to a SPME sample of sage essential oil (CAR/PDMS sampling of 1.0 g essential oil in 20 ml glass vial for 20 sec);

FIG. 11 is an illustration of GC-EAD responses of Western yellowjacket and European paper wasp worker antennae to a SPME sample of citronella essential oil (CAR/PDMS sampling of 1.0 g essential oil in 20 ml glass vial for 20 sec);

FIG. 12 is an illustration of GC-EAD responses of Western yellowjacket worker antennae to a SPME sample of wintergreen essential oil (CAR/PDMS sampling of 1.0 g essential oil in 20 ml glass vial for 20 sec);

FIG. 13A shows a front view of a first embodiment of a repellent composition stick pack in accordance with the present invention;

FIG. 13B shows a side view of the repellent composition stick pack shown in FIG. 13A;

FIG. 13C shows an end view of the repellent composition stick pack shown in FIG. 13A;

FIG. 14 shows schematically a cross section of the repellent composition stick pack through section 2-2 in FIG. 13A, showing a repellent composition therein;

FIG. 15 shows a fragmentary cross-sectional view of a sheet material for repellent composition stick packs in accordance with the present invention, wherein the various dimensions are exaggerated to illustrate aspects of the sheet material;

FIG. 16 shows schematically a system diagram for an apparatus for producing the repellent composition stick pack shown in FIG. 13A, packaged with a repellent composition;

FIG. 17 is a flow diagram illustrating an exemplary method for controlling the rate of release of volatiles of repellent compositions in accordance with the present invention;

FIG. 18 illustrates another embodiment of a multi-compartment repellent composition stick pack in accordance with the present invention;

FIG. 19 illustrates another embodiment of a repellent composition stick pack, having a window portion for the controlled release of volatiles;

FIGS. 20A and 20B illustrate a panel for forming another embodiment of a repellent composition stick pack in accordance with the present invention, wherein FIG. 20B is a sectional view through section 20B-20B in FIG. 20A; and

FIG. 21 is a perspective view of the stick pack formed from the panel shown in FIGS. 20A and 20B.

### DETAILED DESCRIPTION

Plant essential oils are one of the major types of botanical products used for insect control. These oils are major sources of highly active and potent metabolites with strong impacts on insect biology, behavior, and physiology. In addition, essential oils have low environmental persistence and mammalian toxicity. More relevantly, they are normally available in large quantities at reasonable prices due to their widespread use as fragrance an food flavors. Essential oils are typically derived by steam distillation from many plant families. They mainly include complex blends of hydrocarbons (monoterpenes and sequiterpenes) and oxygenated compounds such as alcohols, esters, ethers, aldehydes, ketones, lactones, phenols, phenol ethers, and alkaloids. Many essential oils have been shown to have high repellency against various biting insects/arthropods (such as mosquitoes, sand flies, ticks, and other health related pests), and several agricultural pests (such as the green peach aphid, Myzus persicae; onion aphid, Neotoxoptera formosana; maize weevil, Sitophilus zeamais; red flour beetle, Tribolium castaneum; two spotted spider mite, Tetranychus urticae; Resselivella oculiperda; and Japanese beetle, Popillia japonica Newman). Owing to their aromatic properties, the inventors believe that essential oils would also be a good source of natural repellents for stinging social wasps, namely, yellowjackets, paper wasps, and hornets. Furthermore, combinations of repellents (and their release devices) with known attractants (and traps) in a “push-pull” fashion may strengthen the capacity to combat the serious public health problems against the pestiferous vespid wasps.

Unwittingly, many people might engage in activities that include sources which release compounds that attract insects. When people dine outdoors, sugar and protein containing foods are common sources of compounds that, when emitted into the air, can result in the attraction of unwanted wasps and similar flying insects. It would be desirable to provide protection against insects to persons engaging in such activities. In other circumstances, vespid wasps may happen to build their nests in proximity to areas where people might be present, such as along walkways, in paths, in trees, or on the grounds of nearby homes or businesses. Close proximity of persons to wasps might evoke a defensive reaction from the wasps. Accordingly, it would be desirable to repel insects from certain spaces or surfaces. The present disclosure can advantageously provide such protection. Space as used herein refers to any areas including air space, ground space and in or on things, plants, humans, or other animals. The present disclosure advantageously provides for such uses as well as others. In one embodiment, the present disclosure describes a method for controlling insects. Controlling insects, as used herein, means to change a behavior of the insect, such as to cause the insect to be repelled, for example.

The present application describes field tests of the potential repellency of some representative essential oils against several major vespid wasps using attractant-baited traps and identifies antennally active compounds from the behaviorally repellent essential oils, which are likely responsible for the repellency, using headspace sampling (SPME), gas chromatographic (GC)—electroantennographic detection (EAD), and GC-mass spectrometry (MS) to determine behavioral activity (potential repellency) of these EAD-active compounds in the field using attractant-baited traps. It should also be appreciated that any essential oil not specifically listed herein, but that, nevertheless, contains any of the identified compounds as a major constituent therein, is included within the scope of this disclosure. As used herein, “major constituent” refers to a constituent that is present in greater than 5 wt % of the total volatiles.

The behaviorally repellent essential oils (individually or in combination) or their EAD-active and behaviorally repellent synthetic compounds and their isomers (individually or in combination) may be formulated alone or with other ingredients and released at an effective amount from suitable devices or dispensers to provide a spatial attraction-inhibitor/repellent or topical repellent composition for controlling or repelling various species of pestiferous vespid wasps. The essential oils or compounds alone may provide repellency to the insects. Examples of the application of the essential oils or compounds for spatial attraction-inhibition/deterrence/repellency along with topical repellency include, but are not limited to: for use as a spatial repellent or attraction-inhibitor, the methods may include releasing into a space where one wants to provide such inhibiting or deterring or repelling effect or, in the case of an individual, dispensing or applying onto a protection device, such as a dispenser for a human target or for another animal, at least one essential oil as described herein, or at least one synthetic compound, or combinations thereof, as described herein. The method may also include releasing into the space or surface any other essential oil(s) not listed but containing any identified repellent compound(s) as a major constituent.

In some embodiments, employment of a repellent composition and a controlled release device provides repellency. Such devices are described herein, and it is noted that selection of a device may enhance the effects of the repellent composition as adjusting and metering the concentration of the volatilized repellent composition per cubic meter of air helps to achieving maximum repellency. Factors affecting device selection include the insect targeted, time of year (as temperature correlates to a volatile's release rate), environment (e.g., closed space, open space, calm day, windy day, low humidity environment (e.g., Arizona), and high humidity environment (e.g., New York)). Use of a controlled release device in combination with a repellent composition may provide repellency effects that are greater than use of the repellent composition alone.

The repellent essential oils or synthetic compounds disclosed herein may be formulated into and released at an effective amount from various suitable devices or dispensers with their formulations in either the form of a liquid, a solid, a gel, or any combination thereof as a spatial or topical deterrent, a repellent, or an attraction-inhibitor composition. As the active ingredients, the essential oil(s) or compound(s) may be the only active ingredient in such formulation. Other ingredients may be added for controlling volatility or to provide fragrance, for example. An “active” ingredient is the material responsible for repellency of the insects.

Also provided is a method for repelling an insect, comprising: releasing into a space a repellent composition comprising at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil, wherein the repellent composition is comprised in a controlled release device having at least one aperture configured to achieve a desired rate of release of the repellent composition in a volatilized state into the space; and repelling from the space an insect belonging to the insect family Vespidae, wherein each essential oil of (a) or (b) acts to repel the insect. In some embodiments, the repellent composition comprises two or more first essential oils of (a). In some embodiments, the repellent composition comprises two or more second essential oils of (b). In some embodiments, the repellent composition comprises at least one first essential oil of (a) and at least one second essential oil of (b).

In any embodiment herein, a repellent composition may further comprise at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof. These compounds were identified from the repellent essential oils disclosed above and show strong antennal responses by various social wasp species that are largely responsible for the repellency of the essential oils. Any synthetic isomer of the above disclosed compounds may also be used in any embodiment herein, such as a skeletal isomer or a position isomer, or a stereoisomer.

A controlled release device may comprise a polymeric sheet having a means for permitting the repellent composition in a volatilized state to pass therethrough. The polymeric sheet may comprise a plurality of laminae. An innermost lamina of the plurality of lamina may be semi-permeable such that the repellent composition in a volatilized state can pass through the innermost lamina. In some embodiments, the means for permitting the repellent composition to pass therethrough comprises a plurality of micro-perforations. In some embodiments, the polymeric sheet further comprises an innermost lamina and wherein at least some of the plurality of micro-perforations do not penetrate an innermost lamina of the polymeric sheet. A method may further comprise placing the controlled release device outdoors. For example, a controlled release device may be placed on or near (e.g., within 10 feet) of a target selected from the group consisting of the eaves of a residential building, a commercial building, a fence, a picnic table, a barbeque site, a garbage bin or area, a playground, a recreation park, a tree, a path, a walkway, a deck, a pool, and a campsite to prevent an insect from sensing or approaching the target.

In some embodiments, an insect is selected from the group consisting of paper wasps, yellowjackets, and hornets, or any combination thereof. Non-limiting examples of insects include Polistes annularis; P. apaches; P. aurifer (Golden Paper Wasp); P. bellicosus; P. carolina; P. dominula (European Paper Wasp); P. dorsalis; P. exclamans; P. fuscatus; P. metricus; P. perplexus); Vespula acadica Sladen; V. atropilosa Sladen (Prairie Yellowjacket); V. austriaca Panzer; V. consobrina Saussure (Blackjacket); V. flavopilosa Jakobson (Transition Yellowjacket); V. germanica Fabricius (German Yellowjacket); V. maculifrons Buysson (Eastern Yellowjacket); V. pensylvanica Saussure (Western Yellowjacket); V. squamosa Drury (Southern Yellowjacket); V. sulphurea Saussure (California Yellowjacket); V. vidua Saussure (Forest Yellowjacket); V. vulgaris Linnaeus (Common Yellowjacket); Dolichovespula arenaria Fabricius (Aerial Yellowjackets); D. maculata Linnaeus (Bald-faced Hornet); D. norvegicoides Sladen (Arctic Yellowjacket); Vespa crabro Linnaeus (European Hornet); V. mandarinia Smith (Asian Giant Hornet); and V. orientalis Linnaeus (Oriental Hornet). Any combination of these insects is contemplated.

Also provided is a method for repelling insects, comprising: releasing into a space a repellent composition comprising at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof; wherein the repellent composition is comprised in a controlled release device having at least one aperture configured to achieve a desired rate of release of the repellent composition in a volatilized state into the space; and repelling from the space an insect belonging to the insect family Vespidae, wherein each synthetic compound acts to repel the insect. A repellent composition may further comprise at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil. In some embodiments, the repellent composition comprises two or more first essential oils of (a). In some embodiments, the repellent composition comprises two or more second essential oils of (b). In some embodiments, the repellent composition comprises at least one first essential oil of (a) and at least one second essential oil of (b). In such methods, the controlled release device may be any device described herein, and may be placed in any setting described herein. Insects may be any insect or combination of insects as described herein.

Also provided is a package containing a quantity of a repellent composition, comprising: a stick pack comprising a polymeric sheet having a means for permitting a repellent composition volatile to pass therethrough; and a quantity of volatilizing repellent composition disposed in the stick pack, wherein the repellent composition is substantially in a non-volatilized state; wherein the stick pack is configured to achieve a desired rate of release of repellent composition volatiles though the stick pack. The repellent composition may comprise at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil. A repellent composition may comprise at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof.

Further provided is a repellent composition stick pack for controlling the rate of release of volatiles of a repellent composition comprising: a polymeric sheet having a plurality of micro-perforations, the stick pack defining a volume; and a quantity of repellent composition disposed in the volume; wherein the plurality of micro-perforations are sized and configured to prevent the quantity of repellent composition from escaping from the stick pack in a non-volatilized state and to achieve a desired rate of escape of volatilized repellent composition from the stick pack. The polymeric sheet may comprise a plurality of laminae. An innermost lamina of the plurality of laminae may be semi-permeable such that the repellent composition in the volatilized state can pass through the innermost lamina. In some embodiments, the repellent composition comprises at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil. In some embodiments, the repellent composition comprises at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof.

Also provided is a method for controlling the rate of release of volatiles of a repellent composition comprising: forming a stick pack comprising a polymeric sheet having an inner layer that is permeable to volatiles of the repellent composition and an outer layer that is substantially impermeable to volatiles of the repellent composition; removing a portion of the outer layer defined by a closed contour to define a window portion; providing a quantity of the repellent composition into the stick pack, wherein the repellent composition will gradually volatilize during use; and sealing an end portion of the stick pack such that the quantity of repellent composition is retained in the stick pack. An inner layer may comprise a plurality of micro-perforations therethrough. A repellent composition may comprise at least one of (a) or (b): (a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof; (b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil. A repellent composition may comprise at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof.

Further provided is a method for controlling the rate of release of volatiles of a repellent composition comprising: forming a stick pack comprising a polymeric sheet having an inner layer that is permeable to volatiles of the repellent composition and an outer layer that is substantially impermeable to volatiles of the repellent composition, wherein the outer layer is removably affixed to the inner layer; cutting a closed contour through the outer layer to define a peel-away portion; providing a quantity of the repellent composition into the stick pack, wherein the repellent composition will gradually volatilize during use; and sealing an end portion of the stick pack such that the quantity of repellent composition is retained in the stick pack. In some embodiments, the inner layer comprises a plurality of micro-perforations therethrough. The inner layer may comprise a plurality of laminae. A depth of the plurality of micro-perforations may be configured such that at least some of the plurality of micro-perforations do not penetrate an innermost lamina. In some embodiments, the closed contour is cut by die cutting.

The essential oils and synthetic compounds of the disclosed methods are volatile, and, thus, one mode of application is to provide the essential oils or compounds in a form that is freely volatile. However, it is within the scope of this disclosure to use the compounds in a manner such that they may be bound to materials that reduce the volatility and slowly release the active repellent compositions.

The repellent essential oils and synthetic compounds disclosed herein are readily available from many commercial chemical supply stores. Synthetic, when used to describe the compounds, means that compounds were purified from a natural source, manufactured or synthesized. Natural sources of these compounds include, but are not limited to, the essential oils: clove oil (Myrtaceae), lemongrass oil (Poaceae), ylang ylang oil (Annonaceae), spearmint oil (Lamiaceae), wintergreen oil (Ericaceae), sage oil (Lamiaceae), rosemary oil (Lamiaceae), geranium oil (Geraniaceae), lavender oil (Lamiaceae), anise oil (Apiaceae), fennel seed oil (Apiaceae), citronella oil (Poaceae), peppermint oil (Lamiaceae), pennyroyal oil (Lamiaceae), thyme oil (Lamiaceae), Roman chamomile oil (Asteraceae), and patchouli oil (Lamiaceae). Methods of isolating these compounds from natural sources are well-known in the art.

Insects include eusocial vespid wasps from the family Vespidae (order: Hymenoptera); the subfamily Polistinae; the subfamily Polybiinae; the subfamily Vespinae; the genera Polistes Latreille; the genera Mischocyttarus Saussure; the genera Brachygastra Perty; the genera Polybia Lepeletier; the genera Ropalidia Guérin-Méneville; the genera Vespula Thomson; the genera Dolichovespula Rohwer; the genera Vespa Linnaeus; any wasp species, such as paper wasps (e.g., Polistes annularis; P. apaches; P. aurifer (Golden Paper Wasp); P. bellicosus; P. carolina; P. dominula (European Paper Wasp); P. dorsalis; P. exclamans; P. fuscatus; P. metricus; P. perplexus;); such as yellowjackets (e.g., Vespula acadica Sladen; V. atropilosa Sladen (Prairie Yellowjacket); V. austriaca Panzer; V. consobrina Saussure (Blackjacket); V. flavopilosa Jakobson (Transition Yellowjacket); V. germanica Fabricius (German Yellowjacket); V. maculifrons Buysson (Eastern Yellowjacket); V. pensylvanica Saussure (Western Yellowjacket); V. squamosa Drury (Southern Yellowjacket); V. sulphurea Saussure (California Yellowjacket); V. vidua Saussure (Forest Yellowjacket); V. vulgaris Linnaeus (Common Yellowjacket); Dolichovespula arenaria Fabricius (Aerial Yellowjackets); D. maculata Linnaeus (Bald-faced Hornet); D. norvegicoides Sladen (Arctic Yellowjacket); such as hornets Vespa crabro Linnaeus (European Hornet); V. mandarinia Smith (Asian Giant Hornet); V. orientalis Linnaeus (Oriental Hornet); or any wasp species. In any embodiment, any one or more family, subfamily, genus, or species may be employed. In any embodiment, any one or more family, subfamily, genus, or species may be specifically excluded.

In the embodiments disclosed herein, the one or more insects may include any insect including, but not limited to, insects from the family Vespidae of the order Hymenoptera, and any paper wasp species, yellowjacket species, or hornet species. An embodiment may exclude any one or more of these species. In some embodiments, any one or more of the repellent essential oils and any one or more of the synthetic compounds can be combined to repel a single insect species selected from any insect species belonging to the family Vespidae. In another embodiment, any one or more of the repellent essential oils and any one or more of the synthetic compounds can be combined to repel a subset of insect species selected from the insect species belonging to the family Vespidae. In another embodiment, any one or more of the repellent essential oils and any one or more of the synthetic compounds can be combined to repel a single insect species selected from any insect species belonging to the subfamily Polistinae. In another embodiment, any one or more of the repellent essential oils and any one or more of the synthetic compounds can be combined to repel a subset of insect species selected from the insect species belonging to the subfamily Polistinae. In another embodiment, any one or more of the repellent essential oils and any one or more of the synthetic compounds can be combined to repel a group of insects, including paper wasps, yellowjackets, and hornets. In the above embodiments, any one or more of the repellent essential oils and any one or more of the synthetic compounds can be combined to repel a targeted species of insect or a subset of insect species, while not repelling other species outside the target.

Any essential oil or synthetic compound may comprise about, at most about, or at least about a weight percent of 0.1, 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41, 41.5, 42, 42.5, 43, 43.5, 44, 44.5, 45, 45.5, 46, 46.5, 47, 47.5, 48, 48.5, 49, 49.5, 50, 50.5, 51, 51.5, 52, 52.5, 53, 53.5, 54, 54.5, 55, 55.5, 56, 56.5, 57, 57.5, 58, 58.5, 59, 59.5, 60, 60.5, 61, 61.5, 62, 62.5, 63, 63.5, 64, 64.5, 65, 65.5, 66, 66.5, 67, 67.5, 68, 68.5, 69, 69.5, 70, 70.5, 71, 71.5, 72, 72.5, 73, 73.5, 74, 74.5, 75, 75.5, 76, 76.5, 77, 77.5, 78, 78.5, 79, 79.5, 80, 80.5, 81, 81.5, 82, 82.5, 83, 83.5, 84, 84.5, 85, 85.5, 86, 86.5, 87, 87.5, 88, 88.5, 89, 89.5, 90, 90.5, 91, 91.5, 92, 92.5, 93, 93.5, 94, 94.5, 95, 95.6, 97, 97.5, 98, 98.5, 99, or 99.5% or more, but less than 100%, of a composition, or any range derivable therein.

In any embodiment herein, a composition may comprise a synergistic amount of one or more essential oils, one or more synthetic compounds, or any combination thereof, to provide a synergistic repellency, deterrent, or attraction-inhibitory effect. As used herein, a “synergistic amount” refers to an amount that produces greater than additive effects.

Any embodiment herein may comprise, consist essentially of, or consist of components, ingredients, steps, etc. With respect to “consist essentially of,” such embodiments are drawn to the specified components, ingredients, steps, etc., and those that do not materially affect the basic and novel characteristics of the claimed invention. Non-limiting examples of those that do not materially affect the basic and novel characteristics of the claimed invention include antioxidants (e.g., butylated hydroxytoluene, or BHT) and vegetable oils as inert controlled release agents. With respect to “consist of,” such embodiments are drawn to the specified components only.

The dispensing of such natural essential oils or synthetic compounds may be by way of evaporation or volatilization of the active essential oils or compounds from a device with either a controlled release or a passive release method, such as dispersion by an aerosol or powder that can be scattered on the ground, and the like.

There can also be provided a controlled release device that is used to control the release rate of volatilization of the essential oil(s) or the synthetic compound(s). A release device can be a container having a space therein to house a material onto which one or more of the essential oils or one or more of the compounds is impregnated. The material typically has sufficient free void space to take in or absorb a quantity of essential oils or compounds sufficient to achieve a desired effect (e.g., repellency). Suitable materials can be fibrous, porous, solids, or flexible materials. Suitable materials may include such absorbent materials such as paper, porous plastics, absorbent minerals, carbon, and the like. The release device can have an opening on the outer surface thereof to permit the vapors emitted from the essential oil or oils or compounds to escape the device. Preferably, the device includes means for closing the opening, such as when the device is not in use, and, more preferably, the size of the opening can be made adjustable to allow the user of the device control over whether to emit more or less of the vapors, including complete shut off. The release device can vary in its shape or size to accommodate short periods of efficacy or long periods of efficacy. Devices can come in sizes made to last days or weeks by altering the amount of essential oils and compounds that are loaded into the absorbent material.

The material within the device can be replaced with a new material when the essential oils or synthetic compounds have been depleted. To this end, absorbent materials may come preloaded with the essential oils and compounds and made separately available to be placed in the device by the user. Additionally, the device can be made to accept differing sizes of the absorbent material to allow selecting short or long periods of efficacy. Materials having different essential oils or compounds can be preloaded and made available to a user, such that some essential oils or compounds can be more effective toward one kind of insect. The package may indicate which insect is repelled so that the user is able to change materials, but is only required to purchase one device. This permits a user to tailor the device to a particular length of use and for a particular insect. The devices can be made from plastics or other suitable materials of construction. Devices can be injection molded. Devices can also be wearable by humans as well as animals, such as pets, including, but not limited to dogs and cats. To such end, a release device may include a clip or other means of attachment, such as hook and loop fasteners, a pin, a belt loop, and the like. Other forms of release devices made for the home or an exterior location can vary in their shape or size to fit different settings, such as incorporating the compounds into ornaments to be inconspicuously placed in indoor or outdoor locations, or can be used for dual purposes, such as decorations having insect-repellent properties, and for use in buildings or vehicles.

Furthermore, these repellent devices or dispensing formulations (solids—powders, impregnated plastics, impregnated fibers; or liquids—sprays, aerosols; or gels—creams) can be easily applied outdoors, that is, to outdoor settings such as the eaves of building structures (residential buildings, such as homes; commercial buildings; barns; greenhouses), fences, picnic tables, barbeque sites, garbage bins/areas, playgrounds, recreation parks, trees, paths, walkways, decks, pools, or campsites to prevent vespid wasps (e.g., yellowjackets, paper wasps, and hornets) from sensing or approaching these targets and activities. Such repellent formulations can also be deployed (near the target activity or event centers to push the wasps away) in cooperation with attractants-baited traps (set up around the target activities or events to pull the wasps away from the targets) for these social wasps in a push-pull tactic, which would likely enhance the pest control efficacy against these pestiferous social wasps. Alternatively, the essential oils or synthetic compounds disclosed herein can also be absorbed on a porous substrate or combined with a polymeric gel or formulated into creams, lotions, aerosols, or other suitable formulations for topical application. For repelling pestiferous social wasps from a subject such as a human, a method may comprise the step of applying to the skin of the subject a repellent in an effective dose of at least one essential oil selected from the following essential oils: clove oil, lemongrass oil, ylang ylang oil, spearmint oil, wintergreen oil, sage oil, rosemary oil, geranium oil, lavender oil, anise oil, fennel seed oil, citronella oil, peppermint oil, pennyroyal oil, thyme oil, Roman chamomile oil, patchouli oil; or at least one EAD-active and behaviorally repellent synthetic compound from following candidate chemicals such as I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, or any combination thereof. The method may also include releasing into a space or surface any other essential oil(s) not listed but containing any identified repellent compound(s) as a major constituent.

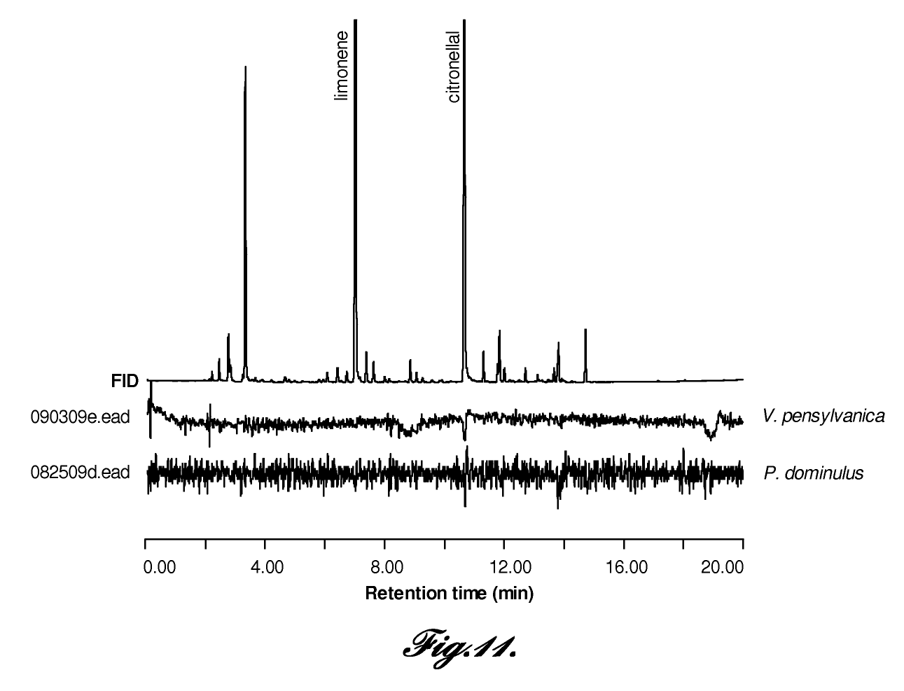

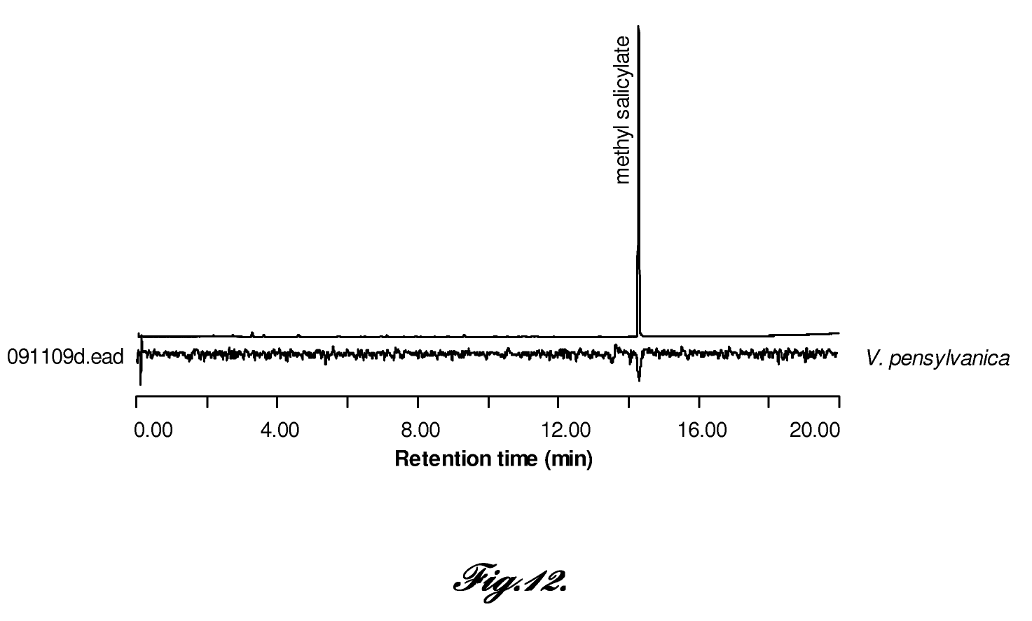

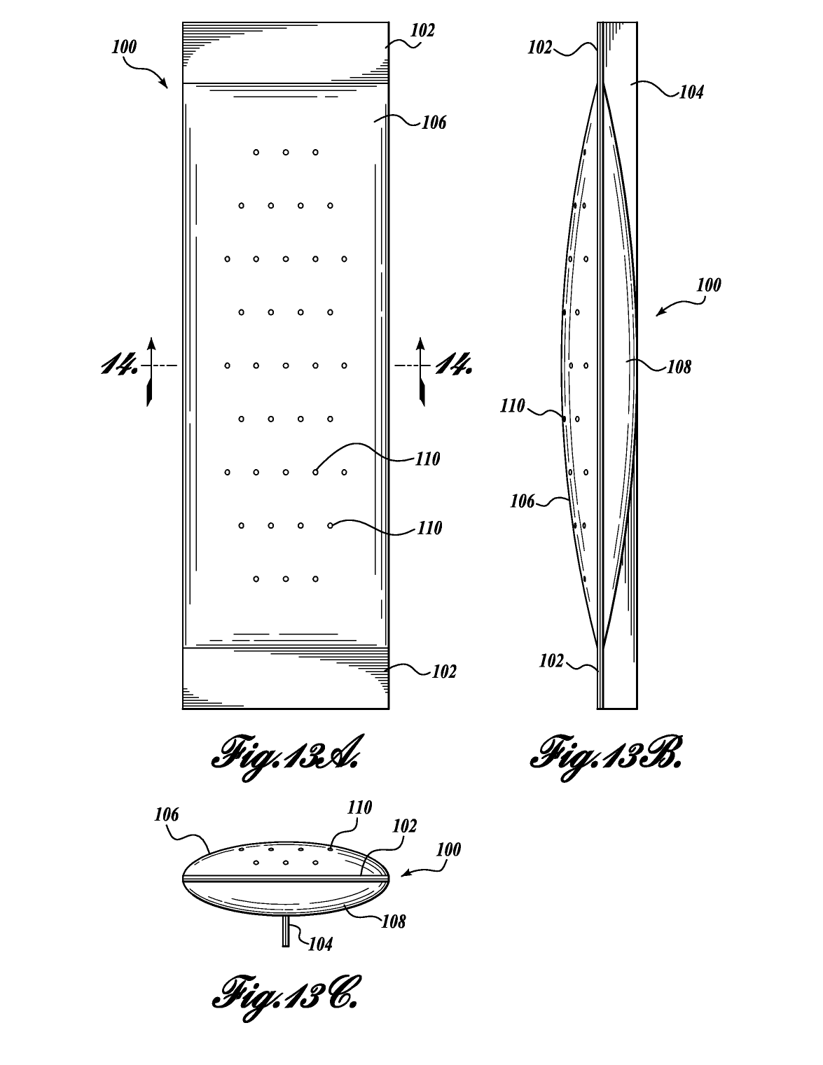

A particular embodiment of a controlled release device is a stick pack including a repellent composition in accordance with the present invention will now be described with reference to the FIGURES, wherein like numbers indicate like parts. FIGS. 13A, 13B, and 13C illustrate front, side, and end views, respectively, of a sachet or stick pack 100 in accordance with the present invention. The stick pack 100 is a generally tubular structure formed from a sheet of material, preferably a polymeric sheet comprising multiple layers. The end portions 102 are sealed transversely, and a longitudinal sealed portion 104 closes the tubular structure, such that a volume is defined between the first and second ends 102.

As discussed below, the properties and configuration of the multiple layers for stick packs 100 cooperatively restrict and control the release rate of volatiles from a repellent composition packaged in the stick pack 100. In particular, the designer may select the materials and certain characteristics of the layers used for the sheet of material to achieve a desired volatile release rate. For example, the layer material properties (e.g., the porosity of the material to the selected repellent composition volatiles), the thickness of the layers, the characteristics of optional apertures, such as micro-perforations (e.g., number, density, size, depth, and shape).

In the embodiment of FIGS. 13A-13C, the front panel 106 of the stick pack 100 includes a pattern of micro-perforations 110 that are sized and configured to achieve a desired release rate of volatiles, as discussed below. In the current embodiment a back panel 108 portion of the stick pack 100 does not include micro-perforations 110. However, it is contemplated that in some applications it will be desirable that the back panel 108 also include micro-perforations.

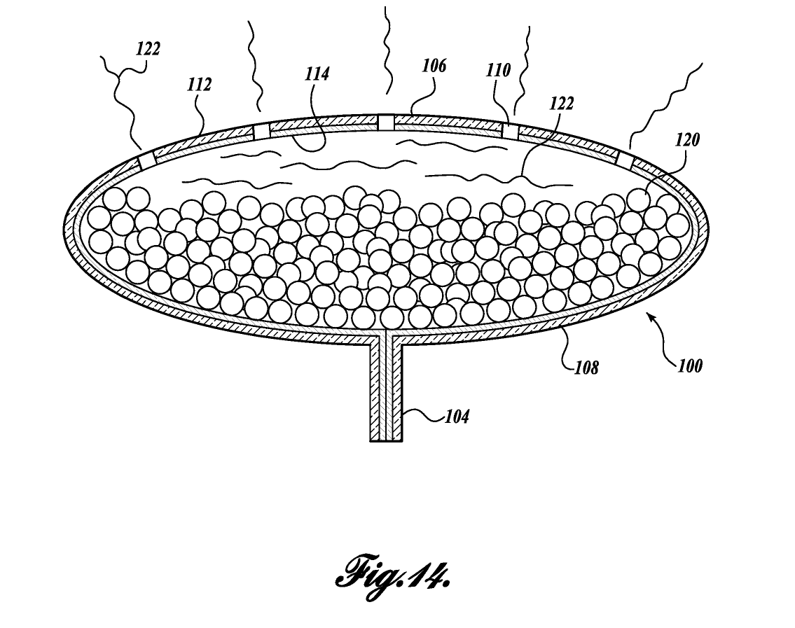

FIG. 14 illustrates a cross section of the stick pack 100, wherein the repellent composition 120 in the stick pack 100 is illustrated generically. In this exemplary embodiment, the innermost layer 114 comprises a material having a relatively low density that is suitable for heat welding to form effective seals. The innermost layer 114 may also be selected for its permeability to the desired repellent composition volatiles. The outermost layer 112 is formed of a relatively higher density material selected for its mechanical strength, dimensional stability, and suitability for manipulation in high speed stick pack machines. The repellent composition 120 may comprise other components that may be desired, for example to stabilize or otherwise affect the chemical or mechanical properties of the composition 120. Other optional components are described herein.

It should be appreciated that although the repellent composition 120 is illustrated in an idealized powder or particulate form in FIG. 14, it is contemplated that the repellent composition 120 may alternatively be in liquid (e.g., oil) form, or incorporated into a gel, paste, or solid matrix, or absorbed into a porous medium such as a sponge or paper, for example. The selected repellent composition volatilizes at the environmental conditions contemplated for its intended use. The quantity of repellent composition 120 may be such that the volume enclosed by the stick pack 100 is only partially filled by the composition 120. The remaining volume in the stick pack 100 may be partially or substantially filled with repellent composition vapors or volatiles 122. The volatiles 122 escape or are gradually released through the micro-perforations 110, or through any permeable barrier defined by the stick pack 100.

It should be readily appreciated that the rate of release of the volatiles 122 will depend in part on the characteristics of the micro-perforations 110. For example, the rate of release may depend on micro-perforation parameters such as (1) the number of perforations; (2) the size or distribution of sizes of the perforations; (3) the spacing and pattern of the perforations; (4) the shape of the perforations (e.g., elongate, star-shaped, circular); (5) the depth of the perforations (e.g., extending partially through the substrate); and (6) any blockage of the perforations. The designer or the user, therefore, have a number of parameters that may be used to control the rate of release of volatiles 122.

For example, the designer may select the size and number of micro-perforations 110 to accommodate a particular repellent composition 120, to achieve a desired release rate. A repellent composition 120 having a low volatility may require more and larger perforations than one with a repellent composition that is highly volatile. In another example, different configurations of micro-perforations 110 may be available, depending on the anticipated environmental conditions (e.g., temperature, humidity) for the expected use of the repellent composition 120. For example, one configuration of micro-perforations in a repellent composition stick pack 100 may be suitable when lower temperatures are expected, and a different configuration may be suitable at higher temperatures. A family of repellent composition stick packs 100 may be made available to users, who will then select the particular stick pack 100 that suits their application. Optionally, a blocking element (not shown), for example, a strip of adhesive, a sleeve, or the like, may be provided to selectively block some portion of the micro-perforations 110, to selectively adjust the rate of release of volatiles 122, for example to adjust for environmental conditions or to accommodate particular situations.

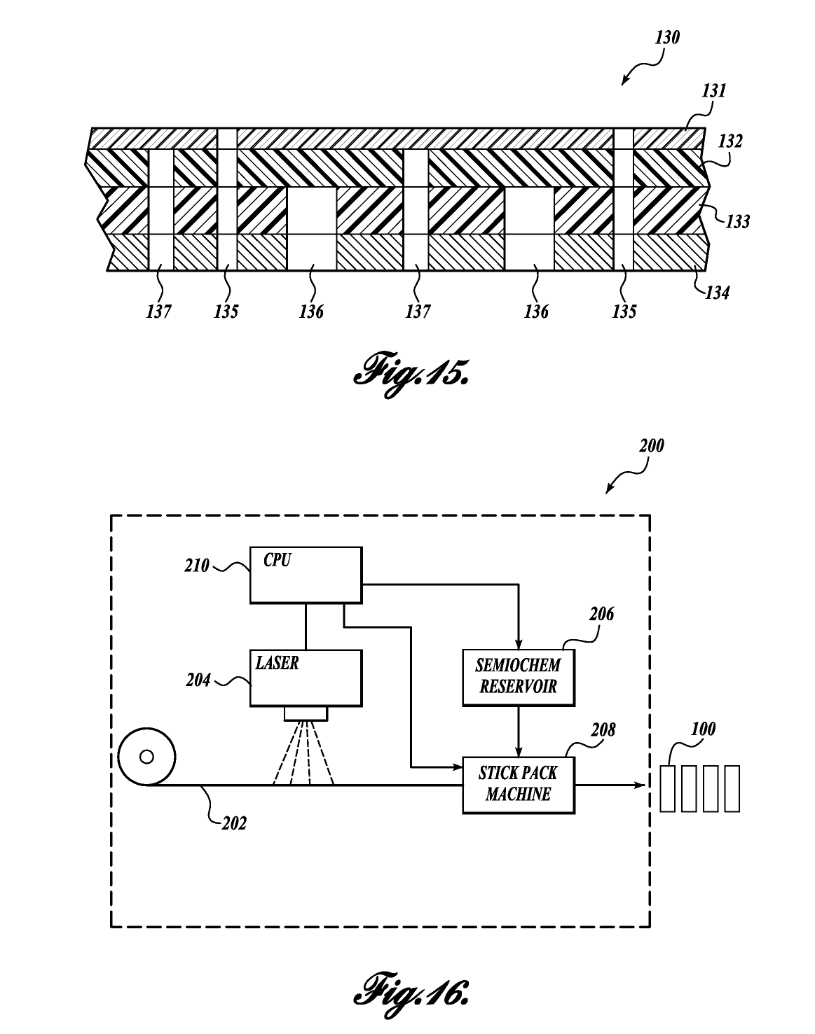

FIG. 15 illustrates an exemplary cross section of a sheet 130 that may be used to form the stick pack 100. The sheet 130 includes one or more polymeric lamina(e), and may additionally include paper or foil lamina(e), for example. In this exemplary embodiment, the sheet 130 comprises four laminae 131, 132, 133, 134. An exemplary total thickness of the sheet 130 is in the range of 1.0 to 10.0 microns. In some embodiments, the total thickness is between about 3.0 microns and 4.0 microns. The multiple laminae 131, 132, 133, 134 may be provided to produce a desired release rate of volatiles 122, and to achieve desired mechanical and manufacturability properties. For example, the material for the innermost lamina 131 may be selected, in part, for its ability to produce good and consistent longitudinal and end seals for the stick pack 100.

One or more of the laminae 131, 132, 133, 134 may also be selected to provide permeability to one or more repellent composition volatiles 122, providing an additional parameter to control the release rate of particular volatiles 122.

In FIG. 15, the micro-perforations have varying diameters and varying depths of penetration through the sheet 130. For example, the micro-perforations 135 are relatively small in diameter and extend through the outer lamina 134 and all of the way through the inner lamina 131. Therefore, molecules of suitable size may escape from the stick pack 100 through the apertures 135. Micro-perforations 136, although relatively large in diameter, only extend through the two outermost laminae 133, 134. Therefore, only molecules that are permeable to the innermost laminae 131, 132 will readily escape through these micro-perforations 136. Micro-perforations 137 are of intermediate diameter, and extend through the three outermost laminae 132, 133, 134 in this exemplary embodiment.

Therefore, it will be appreciated that a stick pack 100 may be designed to contain a plurality of different repellent compositions in a mixture or agglomeration, and to provide different release rates for each of the different repellent compositions.

FIG. 16 illustrates a system 200 for producing a stick pack 100 containing a repellent composition. The system 200 in this embodiment takes a roll of sheet material 202 and selectively directs a laser system 204 to produce a desired pattern of micro-perforations in or through the sheet material 202. Different commercial laser systems are suitable. For example, it is known in the packing industry to use CO₂ lasers, such as “sealed off” coherent CO₂ lasers. Such lasers are suitable for use to process paper, plastic film, and other flexible materials. By some accounts the sealed off coherent CO₂ laser has become a tool of choice to process packaging materials, due to its reliability, low cost, compact footprint, and high quality with respect to laser power and beam characteristics.

A reservoir 206 of the desired repellent composition provides product to a stick pack machine 208 that fills and receives the sheet material 202 and forms the final stick pack 100 of repellent composition 120. The operation is controlled with a computer or stand-alone central processing unit (CPU) controller 210 that may be separate or integrated into the stick pack machine 208. The controller 210 is programmable to accommodate different sheet material 202 and repellent compositions 120, such that the system 200 may be operated to produce any number of different products.

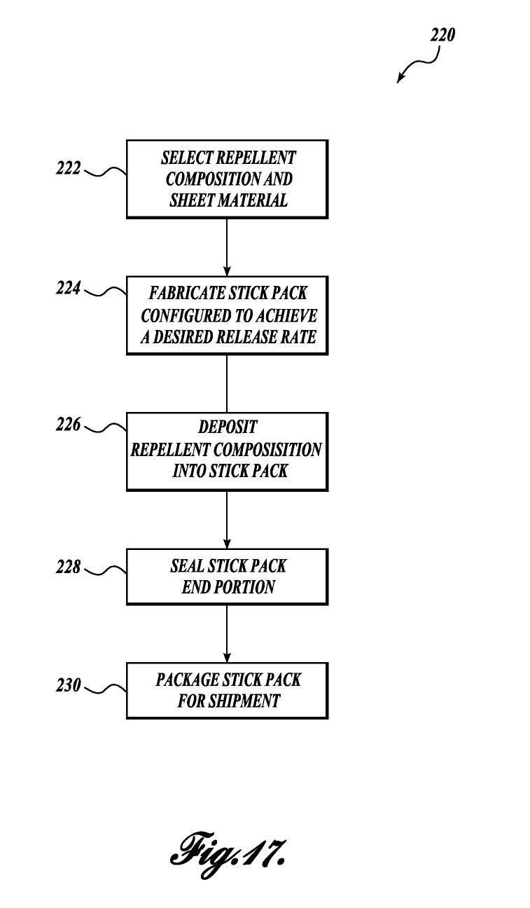

A simplified flow chart 220 of a method in accordance with the present invention is shown in FIG. 17. The user first selects 222 a repellent composition and sheet material for a particular application. A repellent composition is selected with reference to the target insect. The selection of a repellent composition will include selection of the particular form and composition of the repellent composition, including any matrix material that may be useful for stabilizing or controlling the volatilization of the repellent composition. The composition may also include components to confer particular aesthetic aspects to the composition, such as color or scent. A composite sheet material for the stick pack package is also selected. The selection of the sheet material 202 may require consideration of the particular repellent composition selected. For example, the innermost lamina of the sheet material must be compatible with the repellent composition. One or more of the laminae may be selected for their permeability with respect to the repellent composition.

The packaging for the stick pack 100 is fabricated 224, configured for the desired release rate of the volatiles, for example with micro-perforations or selected permeability properties. The selected repellent composition is deposited into the packaging or onto the sheet prior to sealing the package 226. The stick pack ends and longitudinal seam are sealed 228. Typically, the stick pack 100 is then sealed in an outer package 230, for example a foil pack or a plastic package, which is suitable for shipping and display. As an alternative or in addition, it is contemplated that a removable adhesive strip (not shown) may be placed over the micro-perforations, and removed prior to use.

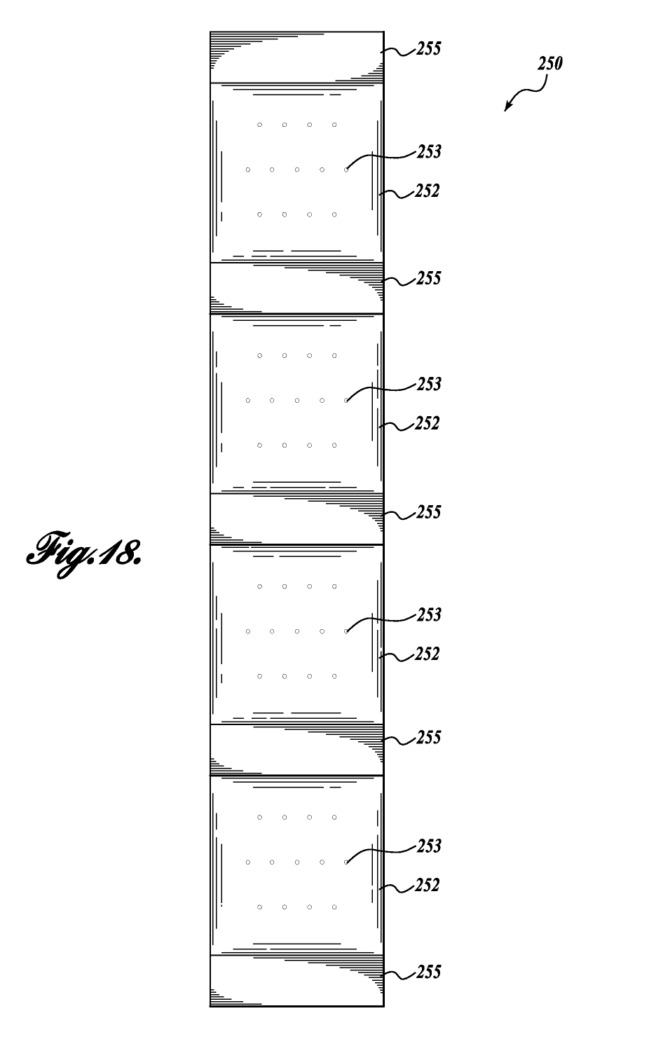

Although the above described stick pack 100 is formed with a single compartment for the repellent composition 120, it is contemplated that the stick pack may be formed with multiple compartments. FIG. 18 illustrates an exemplary multi-compartment stick pack 250. In this embodiment, four separate compartments 252 are defined in the stick pack 250, each separate compartment delineated by sealed ends 255. Although four compartments are shown, more or fewer compartments are also clearly contemplated. The individual compartments may all be of similar or identical physical characteristics, e.g., micro-perforation 253 size, pattern, and depth. For example, separate adhesive strips (not shown) may be applied over the micro-perforations 253 in each compartment 252, such that the compartments 252 may be individually opened for releasing volatiles. This gives a user the option to open multiple compartments 252 initially to increase the rate of release of repellent compositions, or to open each compartment 252 only after the previous compartment repellent composition has been exhausted or lost its effectiveness.

Alternatively, the compartments 252 may be configured differently, for example to accommodate different repellent compositions 120. The multi-compartment stick pack 250 may therefore be readily designed to accommodate different repellent compositions, with the micro-perforations in each compartment 252 tailored to produce a desired rate of release of volatiles for each repellent composition.

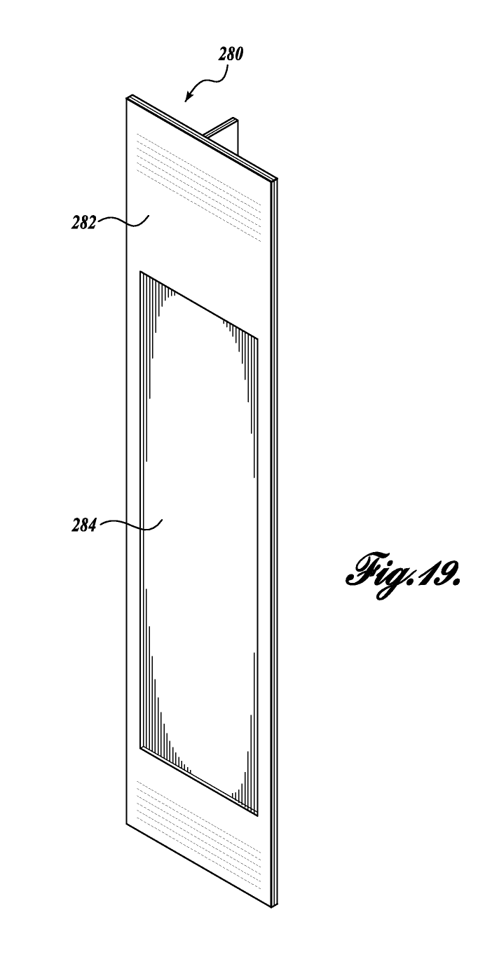

Another exemplary embodiment of a repellent composition stick pack 280 in accordance with the present invention is illustrated in FIG. 19. The stick pack 280 sachet is formed from a sheet material having at least an outermost lamina 282 and an innermost lamina 284. This embodiment is similar to the stick pack 100 described above, except that rather than (or in addition to) a plurality of micro-perforations, windows are formed in the outermost lamina 282, defining an opening or “window” in the sachet that exposes the innermost lamina 284. The innermost lamina 284 may be permeable to the repellent composition volatiles to permit a gradual release rate or may include micro-perforations (not shown) to further control the release rate. The innermost lamina 284 is therefore exposed for release of volatiles. A packaging or other external barrier (not shown) to prevent or mitigate release of the repellent composition before deployment of the stick pack 280 storage before use could be provided. The packaging and stick pack are configured to maintain the integrity of the repellent composition contents over time, e.g., during shipment and storage, such that the repellent composition product will produce the desired release rate and retain its efficacy when the stick pack is deployed.

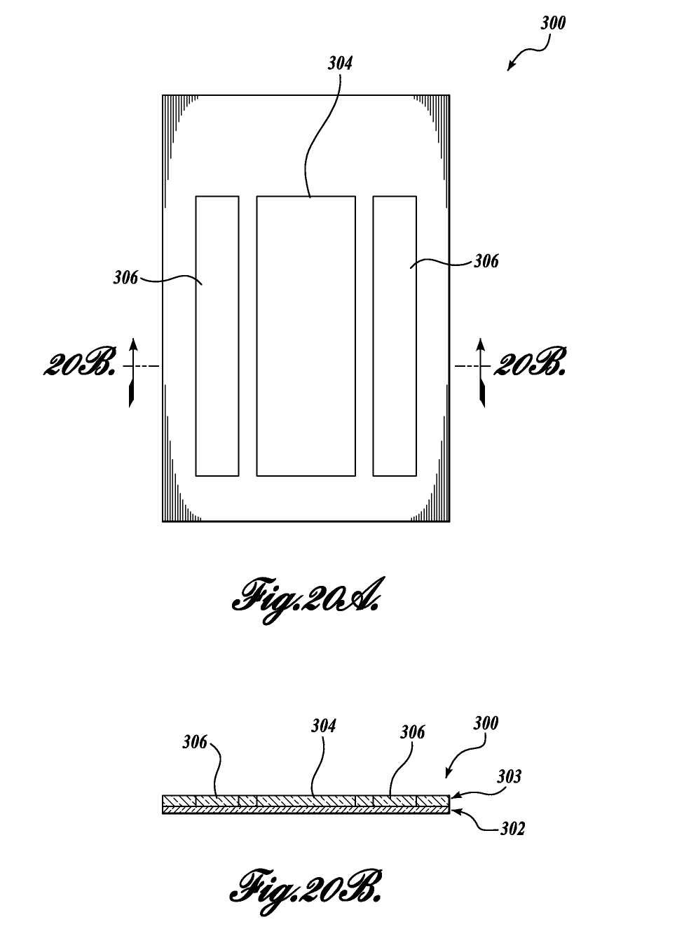

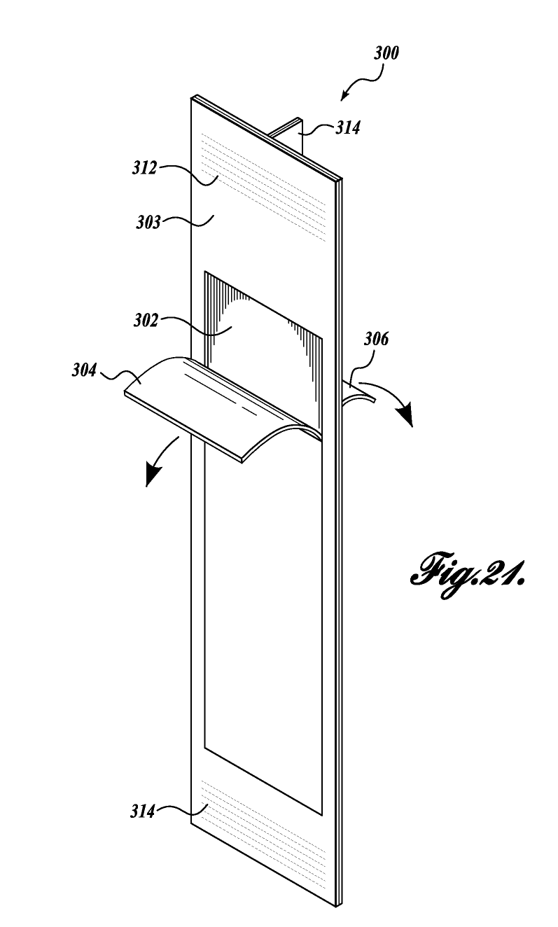

Another exemplary embodiment of a repellent composition stick pack 300 in accordance with the present invention is illustrated in FIGS. 20A, 20B, and 21. FIG. 20A is a plan view of a portion of a sheet of material for producing a single stick pack 300. It will be appreciated that the sheet of material would typically be configured on a continuous roll (not shown), and may include templates or room for multiple stick packs 300 across the width of the roll. FIG. 20B is a cross-sectional view of the unit template shown in FIG. 20A, with the depth dimension exaggerated for clarity.

In this embodiment, the inner layer 302 shown on the bottom in FIG. 20B is configured to define the inner lamina of the stick pack 300, and is adhered to an outermost layer 303. The outermost layer 303 includes one or more peel-away portions 304, 306 that are configured to be removed to from “windows” exposing a portion of the inner layer 302 just prior to use. The inner layer 302 may comprise a plurality of laminae, perhaps including micro-perforations as shown in FIG. 15, or may be a single layer without micro-perforations and having a permeability to the repellent composition to provide the desired release rate.

The perimeter of the peal-away portions 304, 306 may be defined by die-cutting the outer layer 303, for example, wherein the die cut process does not extend through the inner layer 302, or by other means such as laser cutting or the like.

FIG. 21 shows a perspective view of the stick pack 300, fully assembled and therefore containing the desired repellent composition. Lateral end seals 312, 314 close the stick pack 300 at the top and bottom ends, and a longitudinal seal 314 closes the lateral edges to define the tube structure. The first peel-away portion 304 is shown partially removed, to expose a portion of the inner layer 302. One of the second peel-away portions 306 are also shown partially removed.

It will be appreciated that in this embodiment the stick pack 300 does not require a separate external packaging. Moreover, the user has great flexibility in controlling the release rate of the repellent composition contained therein, by selecting how much of the peel-away portions 304, 306 to remove. Accordingly, the stick packs in accordance with the present invention provide a mechanism for very precisely controlling the release rate of repellent compositions contained in the stick pack.

The use of the term “or” in the claims is used to mean “or” unless explicitly indicated to refer to alternatives only or the alternatives are mutually exclusive, although the disclosure supports a definition that refers to only alternatives and “or.”

Throughout this application, the term “about” is used to indicate that a value includes the standard deviation of error for the device or method being employed to determine the value. In any embodiment discussed in the context of a numerical value used in conjunction with the term “about,” it is specifically contemplated that the term about can be omitted.

Following long-standing patent law, the words “a” and “an,” when used in conjunction with the word “comprising” in the claims or specification, denotes one or more, unless specifically noted.

### EXAMPLES

### Materials and Methods

Headspace Sampling of Essential Oils and Collection of Insects

Headspace volatiles from greater than 10 types of essential oils (1 ml each in a closed 20 ml glass vial) were sampled via Solid-Phase Micro-Extraction (SPME) (CAR/PDMS, 85 μm, Supelco, Bellefonte, Pa.) for 20-30 sec before GC-EAD and GC-MS analyses.

Paper wasp [European paper wasp (Polistes dominulus) or golden paper wasp (P. aurifer)] and yellowjacket [Western yellowjacket (Vespula pensylvanica) or Bald-faced hornet (Dolichovespula maculata)] workers for electrophysiological study were collected from their nests and kept alive at 4° C. before testing.

GC-EAD/MS Analyses of Essential Oils

SPME samples of the various essential oils were injected splitless into a Varian CP-3800 GC equipped with a polar column (HP-INNOWAX; 30 m×0.53 mm×1.0 μm film thickness; Agilent Technologies, Wilmington, Del., USA) and a 1:1 effluent splitter that allowed simultaneous flame ionization detection (FID) and electroantennographic detection (EAD) of either a yellowjacket or paper wasp worker antenna to the separated volatile compounds. Helium was used as the carrier gas, and the injector and detector temperatures were 250° C. and 300° C., respectively. Column temperature was 50° C. for 1 min, rising to 240° C. at 10° C./min, and then held for 10 min. The outlet for the EAD was held in a humidified air stream flowing at 0.5 m/sec over the antennal preparation. EAD recordings were made using silver wire-glass capillary electrodes filled with Beadle-Ephrussi Ringer on freshly cut antennae. The antennal signals were stored and analyzed on a PC equipped with a serial IDAC interface box and the program EAD ver. 2.5 (Syntech, Hilversum, The Netherlands).

Antennally active compounds (FID peaks) in the SPME samples of essential oils were identified by GC-MS on an HP 6890 GC series coupled with an HP 5973 Mass Selective Detector using the same type of GC column and conditions as described above. Compounds were identified by comparison of retention times with those of authentic standards and with mass spectra of standards.

Chemical Standards and Essential Oils

The following authentic chemical standards for chemical identification or field trapping experiments were obtained from various commercial and noncommercial sources: 3-octanol (99%), 6-methyl-5-hepten-2-one (99%), α/β-thujone (65.4%), benzyl acetate (99%), d-carvone (98.5%), β-citronellol (95%), citronellal (85%), eugenol (98%), geraniol (98%), geranyl formate (FCC), geranyl acetate (98%), linalool (97%), methyl benzoate (99%), and methyl salicylate (99%) were obtained from Sigma-Aldrich Chemical (Milwaukee, Wis.); (−)-verbenone from Bedoukian Research Inc., Danbury, Conn.; α-terpineol (>90%), E/Z-citral (>90%), menthone (>96%), and pulegone (>96%) from Vigon International, Inc., East Stroudsburg, Pa.; 4-methylanisole (99%) and 4-terpineol (97%) from Alfa Aesar, Ward Hill, Mass.; 4-nonanone (98%) from Avocado; and 1,8-cineole (99%) from TCI America. E/Z-neptalactone (>95%) and Z/E-neptalactone (>95%) were isolated from catnip oil as described in U.S. Pat. No. 7,375,239.

The following essential oils tested were purchased from Lorann Oil, Inc. (Lansing, Mich.): anise oil, camphor oil, citronella oil, clove oil, eucalyptus oil, fennel seed oil, geranium oil, lavender oil, lemongrass oil, patchouli oil, pennyroyal oil, myrrh oil, Roman chamomile oil, rosemary oil, sage oil, spearmint oil, thyme oil, wintergreen oil, vetiver oil, and ylang ylang oil.

Field Trapping Experiments

Eleven field trapping experiments were carried out from late August to mid-October 2009 in residential and woody areas around Spokane, Wash., USA, mostly using the trap known by the designation Rescue® W•H•Y (except on one occasion that Rescue® Reusable Yellowjacket Traps were used for a natural food attractant; see below for details). The commercial W•H•Y trap has a top chamber and a bottom chamber and is described in U.S. Patent Application Publication No. 2009/0151228. The top chamber is baited with two attractants—one of which is a solid contained in a vial (2-methyl-1-butanol), and the other is a liquid mixed with water (acetic acid). The bottom chamber is baited with a liquid attractant (heptyl butyrate) poured onto a cotton pad. Separation of the two types of attractants (otherwise antagonistic to each other when released from the same chamber) in two chambers creates two focal attraction sources from one trap for different species of wasps, hornets, and yellowjackets. In order to test potential repellency of essential oils or EAD-active synthetic candidate compounds on different types of attractants, W•H•Y traps were baited with either a top attractant or a bottom attractant depending on the experiments. In a special occasion, the commercial Rescue® Reusable Yellowjacket Traps were each baited with 10 g of chopped bacon (loaded into a cartridge) as a natural protein food attractant. Traps were hung 1.5-2.0 m above the ground on either fences or tree branches ca. 5 m apart between each trap and at least 15 m between sets. For each trapping experiment, three sets of traps (i.e., three physical replicates of each treatment) were deployed with their initial trap positions within each set being randomized. To minimize positional effects and obtain more replications, wasp collections and trap re-randomization were carried out when 5-10 wasps were caught in the best traps. Each replicate lasted several days depending on wasp flight activity. Captured wasps were removed from the traps and kept in the zip-bags before returning to the laboratory for recording of the species, gender status, and catch. Repellent candidates (individuals or mixtures) were released from polyethylene bags (3×5 cm; with a fabric felt) with various thicknesses from 2-12 mil (see release rates listed in tables); they were employed inside the same trap chamber as the attractant.

Experiment 1 tested five individual essential oils (pennyroyal, lemongrass, peppermint, clove, and citronella) and two known mosquito repellents (i.e., major components of catnip oil), E/Z-nepetalactone and Z/E-nepetalactone plus a blank control against a mixture of attractant [acetic acid (AA) and 2-methyl-1-butanol (2 MB)] using the W•H•Y traps (both attractant and repellent candidates were released from the top chamber) from for eight consecutive days from August to early September. Experiment 2 tested nine individual essential oils (ylang ylang, vetiver, myrrh, patchouli, geranium, eucalyptus, camphor, spearmint, and wintergreen) plus a blank control against a mixture of attractant (AA+2 MB) using the W•H•Y traps (both attractant and repellent candidates were released from the top chamber) for eight consecutive days from late August to early September. Experiment 3 tested seven individual essential oils (Roman chamomile, sage, fennel seed, rosemary, thyme, anise, and lavender) plus a blank control against a mixture of attractant (AA+2 MB) using the W•H•Y traps (both attractant and repellent candidates were released from the top chamber) for eight consecutive days from late August to early September. Experiment 4 tested two essential oil mixtures (3EO-mix: clove, geranium, and lemongrass in ca. 1:1:1 ratio; and 4EO-mix: clove, geranium, lemongrass, and rosemary in ca. 1:1:1:1 ratio) plus a blank control against a mixture of attractant (AA+2 MB) using the W•H•Y traps (both attractant and repellent candidates were released from the top chamber) for 13 consecutive days in September; the essential oil mixtures alone without attractant were tested in the same experiment. Experiment 5 was similar to experiment 4, but heptyl butyrate was used as the attractant released from the bottom chamber of the W•H•Y traps and the repellent candidates (EO-mix) were also released from the same chamber during the same trapping period as in experiment 4. Experiment 6 also tested these same EO-mix treatments, but was against 10 g of chopped bacon (loaded into a cartridge) as a natural protein food attractant using the Reusable Yellowjacket Traps during the same trapping period as the previous two experiments (4 and 5).

In addition, the repellency of the essential oil mixture (3EO-mix; at 0 cm and 50 cm above the heptyl butyrate attractant) on the landing behavior of yellowjackets was field observed (as experiment 7) on a September day for roughly 1.5 hours in Spokane, Wash. This observation test was conducted in the sun by setting up in a line east to west four portable light gray folding tables (45.7×66.0×67.3 cm) in a level area of grass near a vineyard. These tables were placed approximately 3 m apart. Chairs were set up approximately 4 m away from the tables for the scientists conducting the observations. On each table a black lab support stand was used with a movable metal bar in the horizontal direction clamped to the support stand for placing a repellent PE-bag dispenser (2 ml of 3EO-mix) or blank PE-bag at either 0 cm or 50 cm above the attractant, heptyl butyrate. A white towel was used to cover the black base of the support stand to provide a uniform color. A circle felt pad (3.5 cm diameter) loaded with 3 ml of heptyl butyrate as attractant or left blank for a negative control in a Petri dish (9 cm diameter) was placed on the base of the stand. The four tested treatments included a blank control (no attractant, no repellent), an attractant alone, an attractant plus a repellent dispenser right above it (0 cm) and an attractant plus a repellent dispenser 50 cm above it. The treatments were started in random positions on the tables for the first replicate then re-randomized for the next three replicates in a Latin-square design. Each observation replicate was run for 15 minutes. During that time, the scientist in charge of that table would observe and record the number of yellowjackets or paper wasps that approached the table within 0.5 m, and those that landed on or made contact with the attractant.

Experiment 8 tested six EAD-active synthetic compounds identified from repellent essential oils: 1,8-cineole, 6-methyl-5-hepten-2-one, P/I-menthones, linalool, camphor, and geranyl formate against AA+2 MB as the attractant using W•H•Y traps for 13 consecutive days in September. Experiment 9 tested another six EAD-active synthetic compounds identified from repellent essential oils: β-citronellol, 4-terpineol, α-terpineol, E/Z-citral, (−)-verbenone, and eugenol against AA+2 MB as the attractant using W•H•Y traps for 13 consecutive days in September. Experiment 10 tested nine more EAD-active synthetic compounds identified from repellent essential oils: 3-octanol, citronellal, α/β-thujones, methyl benzoate, benzyl acetate, d-carvone, pulegone, geraniol, and methyl salicylate against AA+2 MB as the attractant using W•H•Y traps for 18 consecutive days from the end of September through mid-October. Experiment 11 tested an EAD-active synthetic compound, 4-methylanisole, identified from ylang ylang oil during late flight season (sixteen consecutive days in October; with very low wasp populations) against AA+2 MB as the attractant using W•H•Y traps.

Statistical Analysis

Trap catch data (number of wasps/trap/visit) and landing/approaching numbers were transformed by log (X+1) and the transformed means were analyzed by ANOVA, followed by the Duncan's multiple-range test (SPSS 16.0 for Windows) at α=0.05.

### Results

Field Bioassays of the Essential Oils

Twenty-one essential oils were tested in Experiments 1-3 against AA/2 MB as attractants from late August to early September. Seventeen essential oils (clove oil, pennyroyal oil, lemongrass oil, ylang ylang oil, spearmint oil, wintergreen oil, sage oil, rosemary oil, lavender oil, geranium oil, patchouli oil, citronella oil, Roman chamomile oil, thyme oil, fennel seed oil, anise oil, and peppermint oil) showed significant repellency on either yellowjackets [Vespula pensylvanica (ca. 90%), plus V. vulgaris, V. germanica, and Dolichovespula maculata] or paper wasps (mainly Polistes dominulus, plus a few of P. aurifer) or both to the attractant AA/2 MB (Tables 1-3; also see Table 11 for summary). Clove oil, lemongrass oil, ylang ylang oil, spearmint oil, wintergreen oil, sage oil, rosemary oil, geranium oil, and lavender oil at 30-45 mg/day releases almost blocked the attraction of these vespid wasps to their AA/2 MB attractants (Tables 1-3; also see Table 11 for summary). Two known mosquito repellents from the catnip oil, E/Z-nepetalactone and Z/E-nepetalactone, also showed partially significant repellency on yellowjackets and paper wasps, with E/Z-nepetalactone being more significant than was

Z/E-nepetalactone (Table 1).

In experiments 4-6, two essential oil mixtures including 3 or 4 strongly repellent oils: 3EO-mix (clove, geranium, and lemongrass at 1:1:1) and 4EO-mix (clove, geranium, lemongrass, and rosemary at 1:1:1:1), respectively, alone were not attractive to either yellowjackets or paper wasps (Tables 4-6). Interestingly, traps baited with either EO-mix alone in experiment 4 had significantly less catches of yellowjackets or paper wasps than did the water blank control traps, indicating a repellency effect by these two EO-mixes on the water as a weak attractant for the wasps (Table 4); whereas in experiments 5 and 6, they were not different from the non-water related blank controls (Tables 5 & 6). 3EO-mix or 4EO-mix almost totally blocked the attraction of both yellowjackets and paper wasps to AA/2 MB or to the natural food attractant, bacon (Table 4 and Table 6); and strongly interrupted the attraction of yellowjackets to heptyl butyrate (Table 5). In experiment 5, paper wasps were not attracted to heptyl butyrate; therefore, no repellency effect of the EO-mix could be shown.

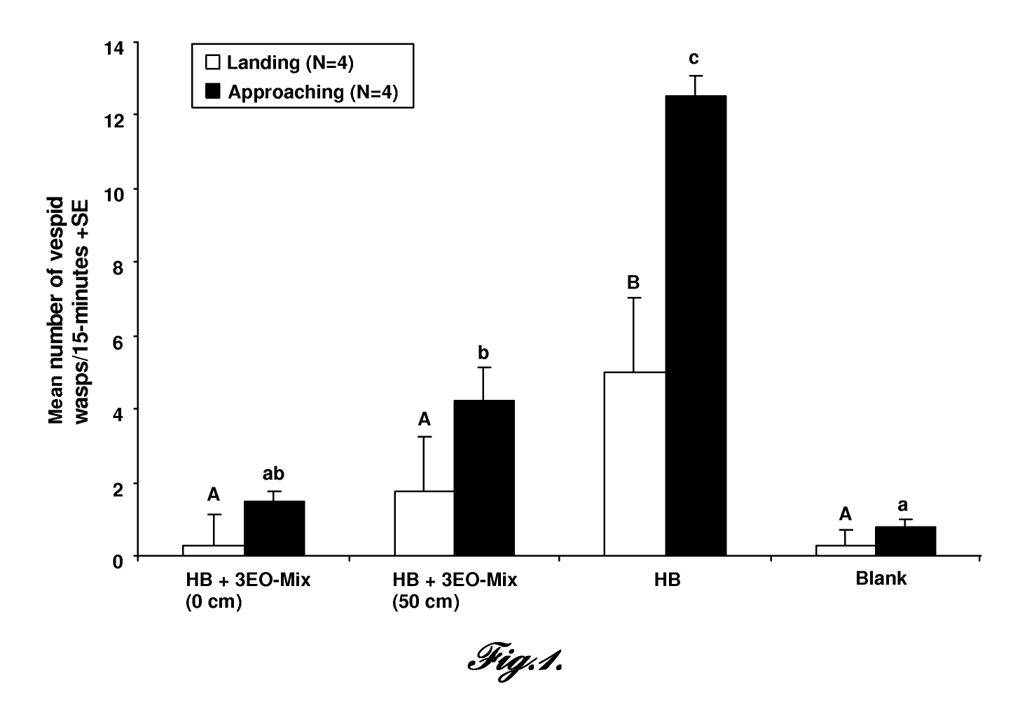

In experiment 7, the attractant (heptyl butyrate: HB) alone attracted a considerable amount of yellowjackets (mainly Vespula pensylvanica) from the surroundings during the minutes of observation, on an average of 5 landing and 12 approaching, respectively (FIG. 1). When adding the essential oil mixture (3EO-mix: clove, geranium, and lemongrass) dispenser to the attractant source at 0 cm above the attractant (i.e., right next to the attractant), the landing and approaching rates of yellowjackets were reduced to the level not different from the blank control (FIG. 1). The 3EO-mix when hung ca. 50 cm above the HB attractant not only significantly reduced the approaching rate by >60% to the attractant source, but, even more importantly, almost blocked the landing of yellowjackets on the HB attractant source (FIG. 1).

GC-EAD/MS Analyses of Behaviorally Active Essential Oils

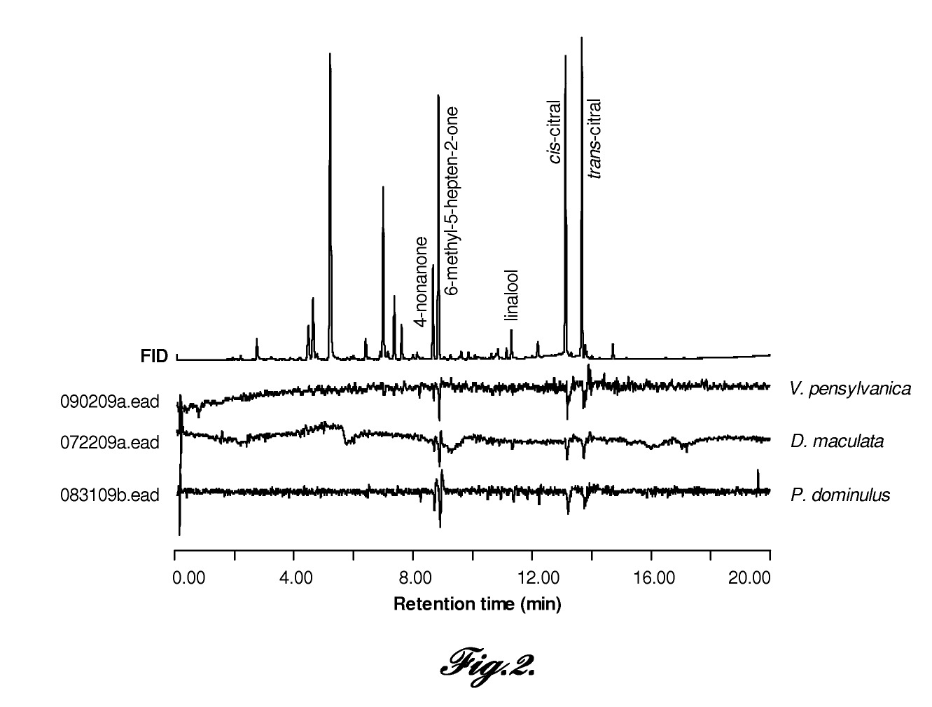

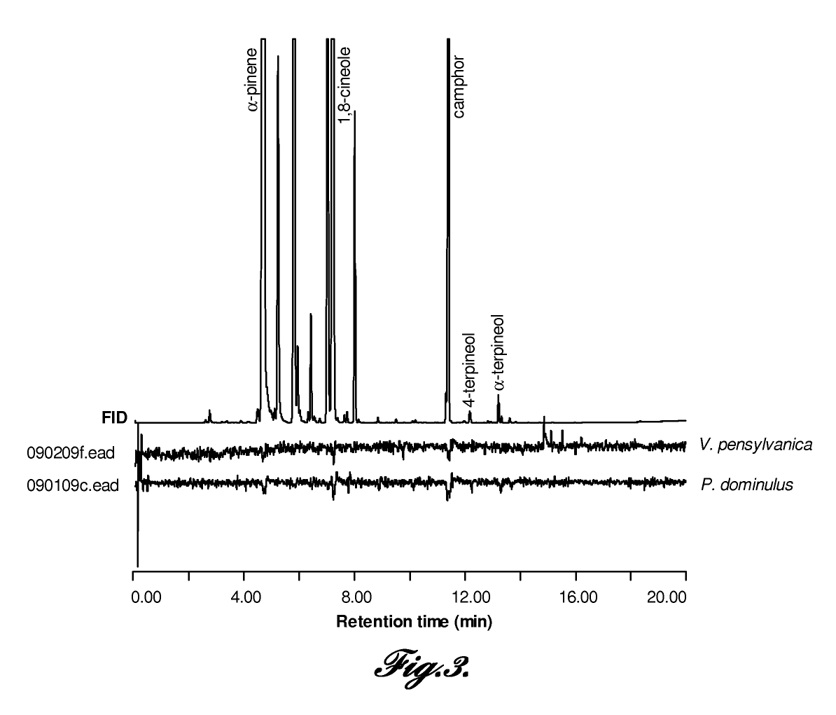

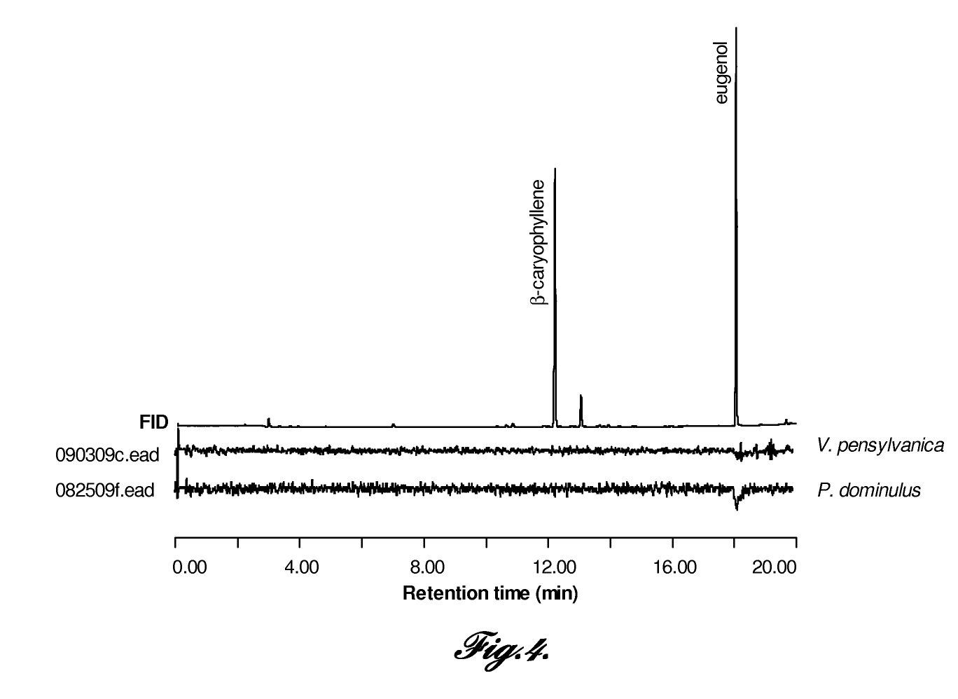

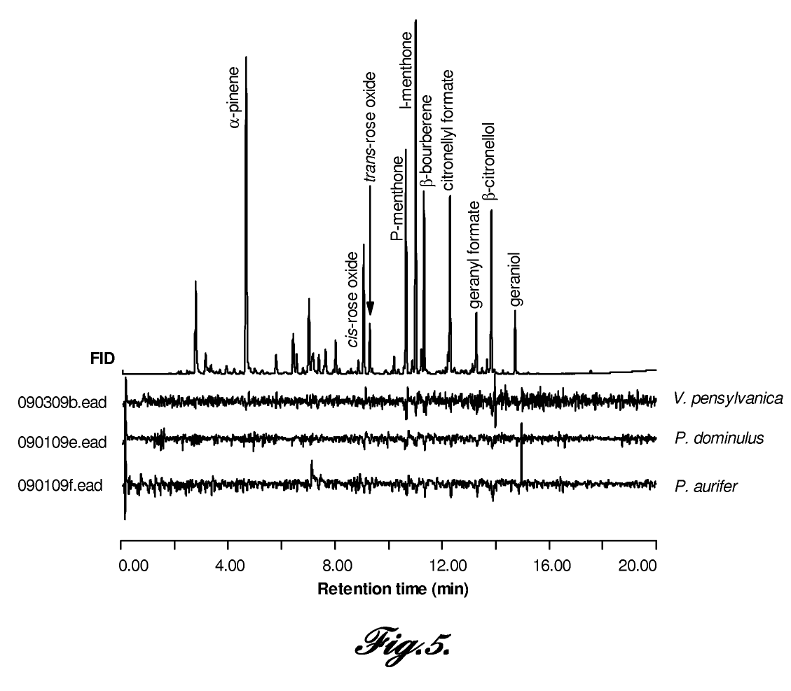

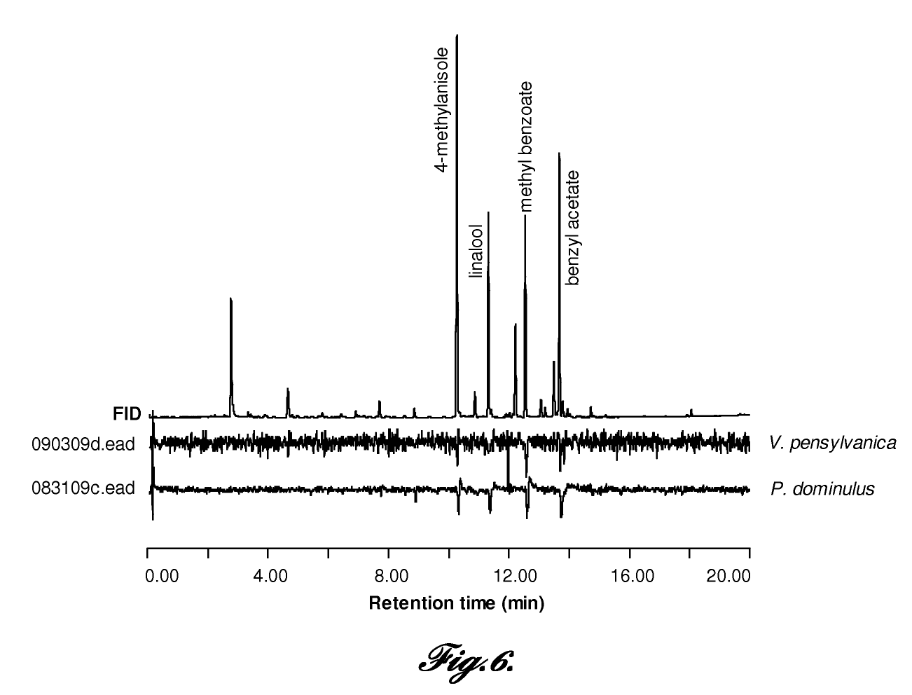

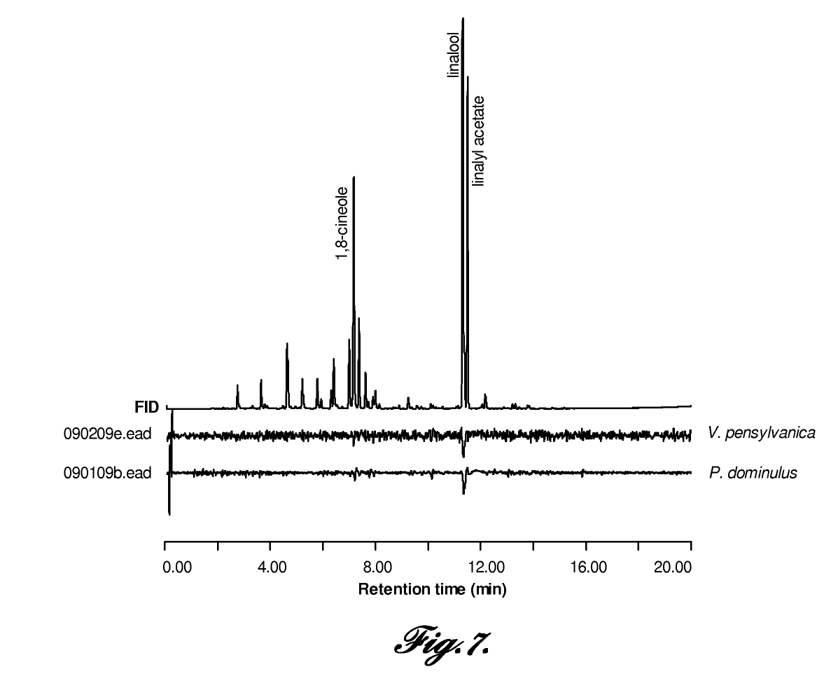

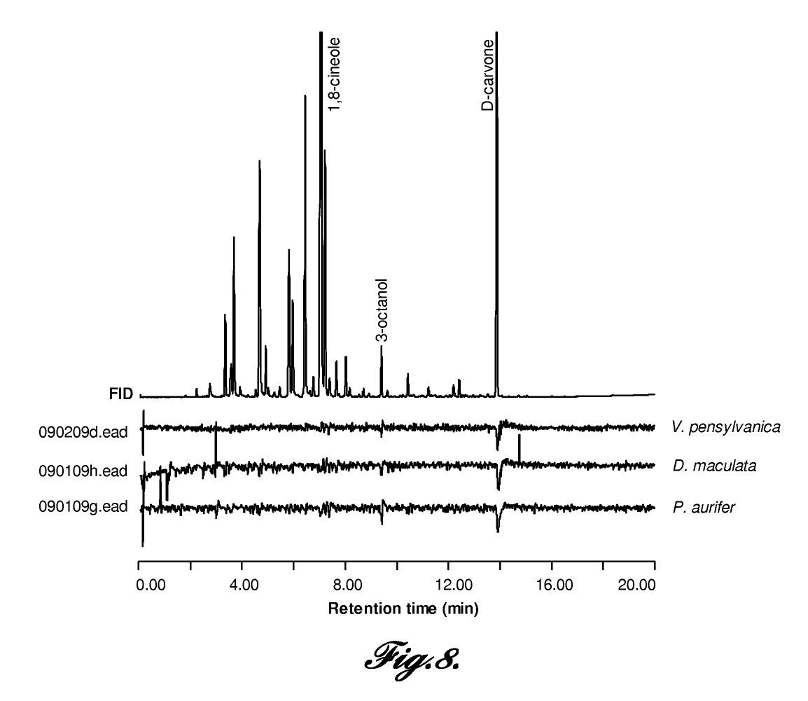

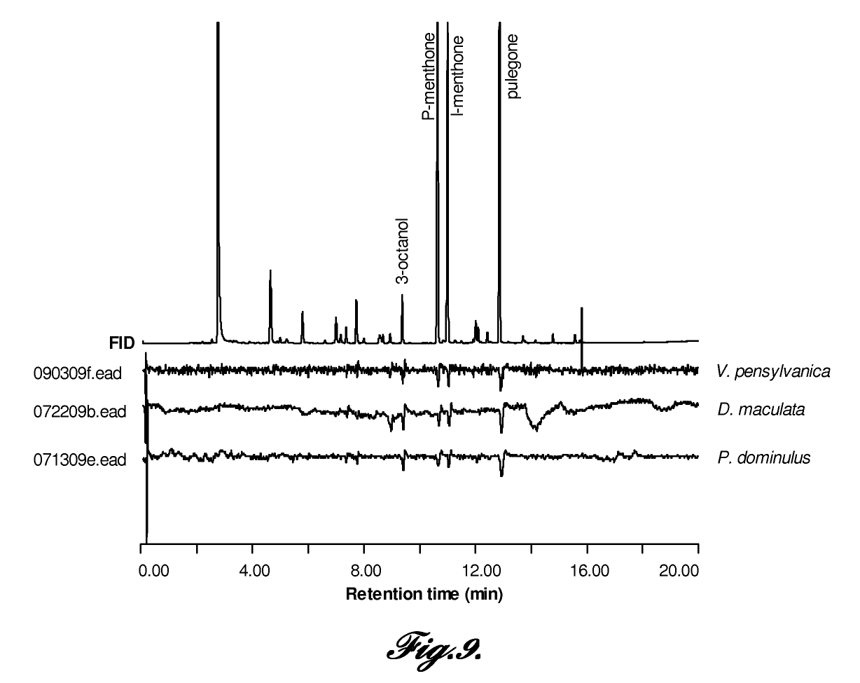

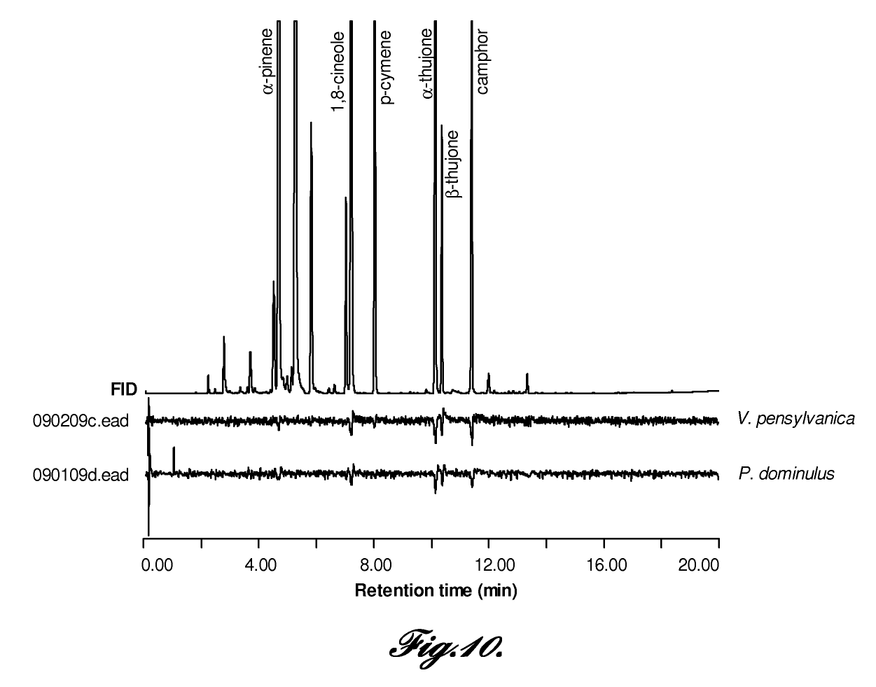

In order to identify the potential chemical compositions from the strong behaviorally repellent essential oils that might be responsible for wasp repellency, a series of GC-EAD/MS analyses were carried out on eleven selected essential oil headspace samples against worker antennae of several yellowjacket and paper wasp species, Vespula pensylvanica, Dolichovespula maculata, Polistes dominulus, and P. aurifer. As shown in FIG. 2, antennae of V. pensylvanica, D. maculata, and Polistes dominulus strongly responded to three major components, E-citral, Z-citral, and 6-methyl-5-hepten-2-one along with two minor components, 4-nonanone and linalool, from the lemongrass oil. These antennally-active compounds were identified using GC-MS by comparison of retention times with those of authentic standards and with the mass spectra of standards. Three major compounds, α-pinene, 1,8-cineole, and camphor along with two minor components, 4-terpineol and α-terpineol, from rosemary oil elicited significant EAD-responses by V. pensylvanica and D. maculata antennae (FIG. 3). A major component, eugenol, from clove oil (FIG. 4); four major components, 4-methylanisole, linalool, methyl benzoate, and benzyl acetate, from ylang ylang oil (FIG. 5); two of the major components, 1,8-cineole and linalool, from lavender oil (FIG. 6); six components, α-pinene, 1,8-cineole, p-cymene, α/β-thujones, and camphor, from sage oil (FIG. 7); and the major component, citronellal, from citronella oil (FIG. 8), elicited strong and repeatable antennal responses by both V. pensylvanica and P. dominulus worker antennae. At least eight compounds from geranium oil (cis/trans-rose oxides, P/I-menthones, β-bourberene, citronellyl formate, geranyl formate, β-citronellol, and geraniol) (FIG. 9); two major components, 1,8-cineole and d-carvone, and a minor component, 3-octanol, from spearmint oil (FIG. 10); and four components, 3-octanol, P/I-menthones, and pulegone, from pennyroyal oil (FIG. 11), showed significant and consistent EAD-responses by V. pensylvanica, D. maculata, P. dominulus, or P. aurifer antennae. The dominant component from wintergreen oil, methyl salicylate, elicited a strong antennal response by V. pensylvanica antennae (FIG. 12).

In short, over 20 EAD-active compounds were identified from 11 selected behaviorally strong active repellent essential oils by four species of vespid wasp workers (see Table 12 for summary). Interestingly, no difference in EAD responses among yellowjacket and paper wasp species was detected.

Field Bioassays of the EAD-Active Synthetic Compounds

Twenty-two synthetic EAD-active compounds (identified from the repellent essential oils) were tested in four field-trapping experiments (experiments 8-11) against a powerful sugar-related attractant, AA/2 MB. In experiment 8, traps baited with the attractant (AA/2 MB) plus P/I-menthone caught significantly less (four times less) yellowjackets than did the attractant alone, while the other five compounds, 1,8-cineole, 6-methyl-5-hepten-2-one, linalool, camphor, and geranyl formate, were not significantly repellent at the doses tested (Table 7). P/I-menthone also showed >50% trap catch reduction to the paper wasps, but it was not statistically different from the attractant alone due to the overall low trap catches (low population density) (Table 7). In experiment 9, E/Z-citral and eugenol significantly reduced trap catches of yellowjackets by more than 70% and 95%, respectively; and they decreased trap catches of paper wasps by 88% and 58%, respectively. Four other tested compounds, β-citronellol, 4-terpineol, α-terpineol, and (−)-verbenone were inactive at doses tested (Table 8). In experiment 10, eight of the nine tested candidate compounds, 3-octanol, citronellal, α/β-thujones, methyl benzoate, benzyl acetate, d-carvone, pulegone, and methyl salicylate showed significant repellency (57-83%) effect on both yellowjackets and paper wasps, whereas geraniol was not different from the attractant alone at the dose tested (Table 9). In experiment 11, the only tested candidate compound, 4-methylanisole, did not show significant repellency to either yellowjackets or paper wasps at 90 mg/day release (Table 10). Overall, 50% of the synthetic EAD-active compounds tested showed a significant repellency on either yellowjackets or paper wasps or both (see Table 13 for summary).

### DISCUSSION

This patent application discloses various essential oils and their chemical compositions are repellent candidates (or attraction-inhibitors) for pestiferous social wasps, namely yellowjackets, paper wasps, and hornets. Seventeen of the twenty-one essential oils tested showed significant repellency on either yellowjackets [Vespula pensylvanica (ca. 90%), plus V. vulgaris, V. germanica, and Dolichovespula maculata] or paper wasps (mainly Polistes dominulus, plus a few of P. aurifer) or both to the attractant AA/2 MB. Of these, clove oil (Myrtaceae), lemongrass oil (Poaceae), ylang ylang oil (Annonaceae), spearmint oil (Lamiaceae), wintergreen oil (Ericaceae), sage oil (Lamiaceae), rosemary oil (Lamiaceae), geranium oil (Geraniaceae), and lavender oil (Lamiaceae) at 30-45 mg/day releases totally blocked the attraction of these vespid wasps to their AA/2 MB attractants (Table 11). About 50% of the significantly active or strongly active repellent essential oils in this study were derived from the family Lamiaceae.

Two essential oil mixtures [3EO-mix (clove, geranium, and lemongrass) and 4EO-mix (clove, geranium, lemongrass, and rosemary)] in tests showed remarkably strong repellency; in fact, they totally blocked the attraction of both yellowjackets and paper wasps to AA/2 MB or to a natural food attractant, bacon (Table 4 and Table 6); and strongly interrupted the attraction of yellowjackets to a powerful attractant, heptyl butyrate (Table 5). The total blocking effect of this 3EO-mix was also shown in a field observation experiment where it was deployed at 50 cm (away from) above the attractant source (FIG. 1). Such significant repellency against all three common types of attractants clearly indicated that these essential oils (individuals or in mixtures) would have a great potential to repel these pestiferous wasps from human food sources and activities. One of the advantages for essential oil mixtures is the potential synergistic (or at least additive) effect among the individual oils and release rate complementary effect of more or less volatile compounds from different oils for a long lasting repellency.

GC-EAD analysis clearly showed that the wasp antennae do have olfactory receptor neurons for detecting various essential oils and some of their volatile compounds (FIGS. 2-12). Twenty-nine EAD-active compounds were identified from 11 selected behaviorally strong repellent essential oils by four species of vespid wasp workers (Table 12). No difference in EAD responses among yellowjacket and paper wasp species was detected, suggesting that yellowjackets, paper wasps, and hornets share many common receptor neuron types and respond to the same or similar volatile repellent compositions. EAD activity is an indicator that the compound may be behaviorally active; and in cases of repellent essential oils, EAD-active compounds are likely responsible for the oil repellency to the social wasps. In fact, over 50% of the 22 synthetic EAD-active compounds tested showed a significant repellency on either yellowjackets or paper wasps or both in the field trapping experiments (Table 13). These EAD-active and behaviorally repellent volatile compounds showed both similarity and diversity in terms of chemical structures, including monoterpene aldehydes, alcohols, and ketones; phenolproponoids; and straight chain alcohols among many others (Table 12 and Table 13).

TABLE 1
Captures of social wasps in Rescue WHY traps baited with either attractant
alone or attractant plus different essential oils, Spokane, WA, USA;
eight consecutive days from late August to early September

| Treatment | Repellent | Mean/trap/visit ± SE* | | | |
|---|---|---|---|---|---|
| Attractant + Essential | release rate | | | Paper | |
| oil/Chemical | (mg/d) | Yellowjackets** | N | wasps*** | N |
| AA/2MB + Pennyroyal | 30 | 51.3 ± 19.4 c | 9 | 6.2 ± 2.2 c | 9 |
| AA/2MB + Lemongrass | 35 | 2.1 ± 1.3 a | 9 | 0.0 ± 0.0 a | 9 |
| AA/2MB + Peppermint | 35 | 24.6 ± 7.7 bc | 9 | 6.0 ± 2.2 c | 9 |
| AA/2MB + Clove | 30 | 0.8 ± 0.4 a | 9 | 0.9 ± 0.8 ab | 9 |
| AA/2MB + Citronella | 45 | 27.8 ± 12.8 bc | 9 | 9.2 ± 4.3 c | 9 |
| AA/2MB + EZ-Neptalactone | 10 | 11.2 ± 3.6 b | 9 | 3.2 ± 1.1 bc | 9 |
| AA/2MB + ZE-Neptalactone | 10 | 52.1 ± 16.2 cd | 9 | 11.3 ± 4.5 c | 9 |
| AA/2MB | | 116.0 ± 32.1 d | 9 | 32.4 ± 11.1 d | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer.

TABLE 2
Captures of social wasps in Rescue WHY traps baited with either attractant
alone or attractant plus different essential oils, Spokane, WA, USA;
eight consecutive days from late August to early September

| Treatment | Repellent | Mean/trap/visit ± SE* | | | |
|---|---|---|---|---|---|
| Attractant + | release rate | | | Paper | |
| Essential oil | (mg/d) | Yellowjackets** | N | wasps*** | N |
| AA/2MB + Ylang Ylang | 30 | 1.1 ± 0.8 a | 9 | 0.7 ± 0.4 a | 9 |
| AA/2MB + Vetiver | 5 | 41.3 ± 14.4 de | 9 | 18.0 ± 12.6 abc | 9 |
| AA/2MB + Myrrh | 1 | 40.6 ± 11.2 e | 9 | 20.9 ± 8.3 bc | 9 |
| AA/2MB + Patchouli | 15 | 22.3 ± 10.8 bcd | 9 | 1.9 ± 1.1 ab | 9 |
| AA/2MB + Geranium | 20 | 4.8 ± 2.3 abc | 9 | 3.1 ± 2.6 a | 9 |
| AA/2MB + Eucalyptus | 145 | 20.0 ± 8.8 bcde | 9 | 28.0 ± 16.4 abc | 9 |
| AA/2MB + Camphor | 70 | 25.1 ± 8.7 cde | 9 | 30.8 ± 17.2 bc | 9 |
| AA/2MB + Spearmint | 40 | 2.3 ± 1.15 ab | 9 | 1.9 ± 1.3 a | 9 |
| AA/2MB + Wintergreen | 45 | 2.3 ± 1.07 ab | 9 | 2.0 ± 1.4 a | 9 |
| AA/2MB | | 38.8 ± 14.4 de | 9 | 26.3 ± 13.0 c | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer.

TABLE 3
Captures of social wasps in Rescue WHY traps baited with either attractant
alone or attractant plus different essential oils, Spokane, WA, USA;
eight consecutive days from late August to early September

| Treatment | Repellent | Mean/trap/visit ± SE* | | | |
|---|---|---|---|---|---|
| Attractant + | release rate | | | Paper | |
| Essential oil | (mg/d) | Yellowjackets** | N | wasps*** | N |
| AA/2MB + Roman Chamomile | 15 | 20.0 ± 6.9 c | 9 | 2.0 ± 0.8 b | 9 |
| AA/2MB + Sage | 30 | 0.3 ± 0.2 a | 9 | 0.1 ± 0.1 a | 9 |
| AA/2MB + Fennel Seed | 45 | 4.0 ± 1.7 ab | 9 | 0.7 ± 0.5 ab | 9 |
| AA/2MB + Rosemary | 45 | 0.2 ± 0.1 a | 9 | 0.0 ± 0.0 a | 9 |
| AA/2MB + Thyme | 50 | 17.4 ± 7.0 bc | 9 | 1.6 ± 0.7 b | 9 |
| AA/2MB + Anise | 60 | 6.4 ± 1.9 bc | 9 | 0.8 ± 0.3 ab | 9 |
| AA/2MB + Lavender | 40 | 0.8 ± 0.4 a | 9 | 0.1 ± 0.1 a | 9 |
| AA/2MB | | 43.7 ± 10.4 d | 9 | 7.9 ± 1.5 c | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer

TABLE 4
Captures of social wasps in Rescue WHY traps baited with either attractant
(or essential oil) alone or attractant plus different essential oils,
Spokane, WA, USA; 13 consecutive days in September

| | Repellent | Mean/trap/visit ± SE* | | | |
|---|---|---|---|---|---|
| | release rate | | | Paper | |
| Treatment | (mg/d) | Yellowjackets** | N | wasps*** | N |
| 3EO MIX alone | 35 | 0.1 ± 0.1 a | 18 | 0.2 ± 0.2 a | 18 |
| AA/2MB + 3EO MIX | 35 | 0.7 ± 0.3 a | 18 | 0.3 ± 0.2 a | 18 |
| 4EO MIX alone | 25 | 0.1 ± 0.1 a | 18 | 0.1 ± 0.1 a | 18 |
| AA/2MB + 4EO MIX | 25 | 0.4 ± 0.2 a | 18 | 0.0 ± 0.0 a | 18 |
| AA/2MB | | 62.9 ± 10.1 c | 18 | 8.1 ± 1.6 c | 18 |
| BLANK | | 7.8 ± 2.1 b | 18 | 2.3 ± 0.7 b | 18 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer. AA/2MB as wasp attractant; 3EO MIX: clove, geranium, and lemongrass oils at 1:1:1 in a 2 mil PE-bag; 4EO MIX: clove, geranium, lemongrass, and rosemary oils at 1:1:1:1 in a 4 mil PE bag.

TABLE 5
Captures of social wasps in Rescue WHY traps baited
with either attractant (or essential oil) alone
or attractant plus different essential oils, Spokane,
WA, USA; 13 consecutive days in September

| | Repellent | Mean/trap/visit ± SE* | | | |
|---|---|---|---|---|---|
| | release rate | | | Paper | |
| Treatment | (mg/d) | Yellowjackets** | N | wasps*** | N |
| 3EO MIX | 35 | 0.9 ± 0.35 a | 18 | 0.7 ± 0.3 a | 18 |
| alone | | | | | |
| HB + | 35 | 2.8 ± 0.96 a | 18 | 0.3 ± 0.2 a | 18 |
| 3EO MIX | | | | | |
| 4EO MIX | 25 | 0.4 ± 0.22 a | 18 | 0.6 ± 0.3 a | 18 |
| alone | | | | | |
| HB + | 25 | 5.5 ± 2.73 a | 18 | 0.9 ± 0.5 a | 18 |
| 4EO MIX | | | | | |
| HB | | 39.7 ± 13.6 b | 18 | 1.3 ± 0.6 a | 18 |
| BLANK | | 2.3 ± 1.59 a | 18 | 0.3 ± 0.2 a | 18 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer. HB: heptyl butyrate as wasp attractant; 3EO MIX: clove, geranium, and lemongrass oils at 1:1:1 in a 2 mil PE-bag; 4EO MIX: clove, geranium, lemongrass, and rosemary oils at 1:1:1:1 in a 4 mil PE bag.

TABLE 6
Captures of social wasps in Rescue YJTR traps baited with either
attractant (or essential oil) alone or attractant plus different
essential oils, Spokane, WA, USA; 13 consecutive days in September

| | Repellent | Mean/trap/visit ± SE* | | | |
|---|---|---|---|---|---|
| | release rate | | | Paper | |
| Treatment | (mg/d) | Yellowjackets** | N | wasps*** | N |
| 3EO MIX | 35 | 0.0 ± 0.0 a | 7 | 0.0 ± 0.0 a | 7 |
| alone | | | | | |
| Bacon + | 35 | 0.0 ± 0.0 a | 7 | 0.1 ± 0.1 a | 7 |
| 3EO MIX | | | | | |
| 4EO MIX | 25 | 0.0 ± 0.0 a | 7 | 0.0 ± 0.0 a | 7 |
| alone | | | | | |
| Bacon + | 25 | 0.0 ± 0.0 a | 7 | 0.1 ± 0.1 a | 7 |
| 4EO MIX | | | | | |
| Bacon | | 13.6 ± 6.4 b | 7 | 1.3 ± 0.7 b | 7 |
| BLANK | | 0.0 ± 0.0 a | 7 | 0.0 ± 0.0 a | 7 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer. Bacon as wasp attractant; 3EO MIX: clove, geranium, and lemongrass oils at 1:1:1 in a 2 mil PE-bag; 4EO MIX: clove, geranium, lemongrass, and rosemary oils at 1:1:1:1 in a 4 mil PE bag.

TABLE 7
Captures of social wasps in Rescue WHY traps baited with either
attractant alone or attractant plus different repellent chemical
candidates, Spokane, WA, USA; 13 consecutive days in September

| | Repellent | Mean/trap/visit ± SE* | | | |
|---|---|---|---|---|---|
| Treatment | release rate | | | Paper | |
| Attractant + Chemical | (mg/d) | Yellowjackets** | N | wasps*** | N |
| AA/2MB + 1,8-Cineole | 80 | 18.2 ± 4.1 b | 9 | 4.6 ± 1.8 a | 9 |
| AA/2MB + 6-Methyl-5- | 40 | 21.9 ± 3.8 b | 9 | 4.8 ± 2.3 a | 9 |
| hepten-2-one | | | | | |
| AA/2MB + Menthone | 55 | 7.7 ± 3.4 a | 9 | 2.1 ± 1.3 a | 9 |
| AA/2MB + Linalool | 20 | 23.9 ± 4.0 b | 9 | 5.2 ± 3.5 a | 9 |
| AA/2MB + Camphor | 5 | 30.3 ± 3.4 b | 9 | 7.2 ± 3.7 a | 9 |
| AA/2MB + Geranyl formate | 20 | 28.2 ± 7.0 b | 9 | 5.8 ± 2.7 a | 9 |
| AA/2MB | | 32.4 ± 6.8 b | 9 | 4.6 ± 2.2 a | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer

TABLE 8
Captures of social wasps in Rescue WHY traps baited with either
attractant alone or attractant plus different repellent chemical
candidates, Spokane, WA, USA; 13 consecutive days in September

| | Repellent | Mean/trap/visit ± SE* | | | |
|---|---|---|---|---|---|
| Treatment | release rate | | | Paper | |
| Attractant + Chemical | (mg/d) | Yellowjackets** | N | wasps*** | N |
| AA/2MB + β-Citronellol | 5 | 36.2 ± 6.8 b | 9 | 5.1 ± 1.6 b | 9 |
| AA/2MB + 4-Terpineol | 20 | 23.3 ± 5.6 b | 9 | 2.0 ± 0.7 ab | 9 |
| AA/2MB + α-Terpineol | 15 | 21.9 ± 5.7 b | 9 | 2.2 ± 0.9 ab | 9 |
| AA/2MB + E/Z-Citral | 35 | 11.6 ± 5.8 a | 9 | 0.6 ± 0.3 a | 9 |
| AA/2MB + (−)-Verbenone | 15 | 18.7 ± 5.9 b | 9 | 2.9 ± 0.9 ab | 9 |
| AA/2MB + Eugenol | 15 | 1.7 ± 0.7 a | 9 | 2.0 ± 0.5 ab | 9 |
| AA/2MB | | 39.4 ± 8.6 b | 9 | 4.8 ± 1.9 b | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer

TABLE 9
Captures of social wasps in Rescue WHY traps baited with either attractant
alone or attractant plus different repellent chemical candidates, Spokane,
WA, USA; 18 consecutive days from the end of September though mid-October

| | Repellent | Mean/trap/visit ± SE* | | | |
|---|---|---|---|---|---|
| Treatment | release rate | | | Paper | |
| Attractant + Chemical | (mg/d) | Yellowjackets** | N | wasps*** | N |
| AA/2MB + 3-Octanol | 30 | 6.9 ± 2.4 ab | 9 | 1.1 ± 0.8 a | 9 |
| AA/2MB + Citronellal | 75 | 11.4 ± 5.2 bc | 9 | 0.4 ± 0.2 a | 9 |
| AA/2MB + α/β-Thujone | 35 | 4.9 ± 1.6 ab | 9 | 0.2 ± 0.1 a | 9 |
| AA/2MB + Methyl benzoate | 60 | 5.2 ± 2.2 ab | 9 | 1.9 ± 0.8 ab | 9 |
| AA/2MB + Benzyl acetate | 40 | 8.2 ± 3.0 abc | 9 | 0.9 ± 0.5 a | 9 |
| AA/2MB + d-Carvone | 40 | 4.9 ± 2.2 ab | 9 | 0.9 ± 0.5 a | 9 |
| AA/2MB + Pulegone | 50 | 6.4 ± 1.8 abc | 9 | 0.2 ± 0.1 a | 9 |
| AA/2MB + Geraniol | 5 | 21.8 ± 6.0 cd | 9 | 2.9 ± 0.9 b | 9 |
| AA/2MB + Methyl salicylate | 50 | 4.7 ± 2.0 ab | 9 | 0.9 ± 0.5 a | 9 |
| AA/2MB | | 27.1 ± 6.2 d | 9 | 3.9 ± 1.0 b | 9 |
| BLANK | | 2.0 ± 1.3 a | 9 | 0.8 ± 0.6 a | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer

TABLE 10
Captures of social wasps in Rescue WHY traps baited with attractant
alone or attractant plus different repellent chemical candidates,
Spokane, WA, USA; 16 consecutive days in October

| | Repellent | Mean/trap/visit ± SE* | | | |
|---|---|---|---|---|---|
| Treatment | release rate | | | Paper | |
| Attractant + Chemical | (mg/d) | Yellowjackets** | N | wasps*** | N |
| AA/2MB + 4-Methylanisole | 90 | 10.0 ± 5.0 b | 9 | 0.9 ± 0.5 a | 9 |
| AA/2MB | | 14.0 ± 5.6 b | 9 | 0.2 ± 0.2 a | 9 |
| BLANK | | 0.1 ± 0.1 a | 9 | 0.3 ± 0.3 a | 9 |

*Means were compared by ANOVA on log (X + 1) followed by Duncan's multiple-range test α = 0.05. Means with the same letter for each species group are not significantly different (P > 0.05).
**Mainly Vespula pensylvanica (ca. 90%), plus V. vulgaris, V. germanica, and Dolichovespula maculata.
***Mainly Polistes dominulus, plus a few of P. aurifer

TABLE 11
Essential oils as repellents for paper wasps, hornets and yellowjackets

| | | Repellency to | | |
|---|---|---|---|---|
| Essential oil | | vespid wasps | | |
| Product name | Family | Strong | Moderate | Weak or inactive |
| Lemongrass | Poaceae | x | | |
| Clove | Myrtaceae | x | | |
| Geranium | Geraniaceae | x | | |
| Rosemary | Lamiaceae | x | | |
| Ylang Ylang | Annonaceae | x | | |
| Spearmint | Lamiaceae | x | | |
| Wintergreen | Ericaceae | x | | |
| Lavender | Lamiaceae | x | | |
| Sage | Lamiaceae | x | | |
| Anise | Apiaceae | x | | |
| Fennel Seed | Apiaceae | x | | |
| Citronella | Poaceae | | x | |
| Peppermint | Lamiaceae | | x | |
| Pennyroyal | Lamiaceae | | x | |
| Thyme | Lamiaceae | | x | |
| Roman Chamomile | Asteraceae | | x | |
| Patchouli | Lamiaceae | | x | |
| Eucalyptus | Myrtaceae | | | x |
| Camphor | Lauraceae | | | x |
| Vetiver | Poaceae | | | x |
| Myrrh | Burseraceae | | | x |

TABLE 12
Vespid wasp EAD-active compounds identified from SPME samples of behaviorally repellent essential oils

| | | | | Ylang | | | | | | | Winter- |
|---|---|---|---|---|---|---|---|---|---|---|---|
| Chemical | Lemongrass | Spearmint | Pennyroyal | ylang | Sage | Geranium | Rosemary | Lavender | Clove | Citronella | green |
| 1,8-cineole | | x | | | x | | x | x | | | |
| 4-nonanone | x | | | | | | | | | | |
| 6-methyl-5-hepten-2-one | x | | | | | | | | | | |
| cis-rose oxide | | | | | | x | | | | | |
| trans-rose oxide | | | | | | x | | | | | |
| 3-octanol | | x | x | | | | | | | | |
| citronellal | | | | | | | | | | x | |
| 4-methylanisole | | | | x | | | | | | | |
| P-menthone | | | x | | | x | | | | | |
| I-menthone | | | x | | | x | | | | | |
| linalool | x | | | x | | | | x | | | |
| α-thujone | | | | | x | | | | | | |
| β-thujone | | | | | x | | | | | | |
| camphor | | | | | x | | x | | | | |
| citronyl formate | | | | | | x | | | | | |
| geranyl formate | | | | | | x | | | | | |
| methyl benzoate | | | | x | | | | | | | |
| benzyl acetate | | | | x | | | | | | | |
| β-citronellol | | | | | | x | | | | | |
| 4-terpineol | | | | | | | x | | | | |
| α-terpineol | | | | | | | x | | | | |
| methyl salicylate | | | | | | | | | | | x |
| d-carvone | | x | | | | | | | | | |
| pulegone | | | x | | | | | | | | |
| E-citral | x | | | | | | | | | | |
| Z-citral | x | | | | | | | | | | |
| (−)-verbenone | | | | | | | x | | | | |
| geraniol | | | | | | | | | | x | |
| eugenol | | | | | | | | | x | | |

TABLE 13
Synthetic candidates (EAD-active) from active essential oils
as repellents for paper wasps, hornets, and yellowjackets

| | Repellency to vespid wasps | | |
|---|---|---|---|
| Chemical | Strong | Moderate | Weak or inactive |
| Menthone | x | | |
| Eugenol | x | | |
| E/Z-Citral | x | | |
| Pulegone | x | | |
| α-/β-Thujone | x | | |
| Methyl benzoate | x | | |
| d-Carvone | x | | |
| Methyl salicylate | x | | |
| E/Z-Nepetalactone | x | | |
| Z/E-Nepetalactone | | x | |
| 3-Octanol | | x | |
| Benzyl acetate | | x | |
| Citronellal | | x | |
| β-Citronellol | | | x |
| 4-Terpineol | | | x |
| α-Terpineol | | | x |
| Geraniol | | | x |
| 1,8-Cineole | | | x |
| 6-Methyl-5-hepten-2-one | | | x |
| Linalool | | | x |
| Camphor | | | x |
| Geranyl formate | | | x |
| (-)-Verbenone | | | x |
| 4-Methylanisole | | | x |

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for repelling an insect, comprising:
releasing into a space a repellent composition comprising at least one of (a) or (b):
(a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof;
(b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil,
wherein the repellent composition is comprised in a controlled release device having at least one aperture configured to achieve a desired rate of release of the repellent composition in a volatilized state into the space; and
repelling from the space an insect belonging to the insect family Vespidae, wherein each essential oil of (a) or (b) acts to repel the insect.

2. The method of claim 1, wherein the repellent composition comprises two or more first essential oils of (a).

3. The method of claim 1, wherein the repellent composition comprises two or more second essential oils of (b).

4. The method of claim 1, wherein the repellent composition comprises at least one first essential oil of (a) and at least one second essential oil of (b).

5. The method of claim 1, wherein the repellent composition further comprises at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof.

6. The method of claim 1, wherein the controlled release device comprises a polymeric sheet having a means for permitting the repellent composition in a volatilized state to pass therethrough.

7. The method of claim 6, wherein the polymeric sheet comprises a plurality of laminae.

8. The method of claim 7, wherein an innermost lamina of the plurality of laminae is semi-permeable such that the repellent composition in a volatilized state can pass through the innermost lamina.

9. The method of claim 6, wherein the means for permitting the repellent composition to pass therethrough comprises a plurality of micro-perforations.

10. The method of claim 9, wherein the polymeric sheet further comprises an innermost lamina and wherein at least some of the plurality of micro-perforations do not penetrate an innermost lamina of the polymeric sheet.

11. The method of claim 1, further comprising placing the controlled release device outdoors.

12. The method of claim 11, wherein the controlled release device is placed on or within 10 feet of a target selected from the group consisting of the eaves of a residential building, a commercial building, a fence, a picnic table, a barbeque site, a garbage bin or area, a playground, a recreation park, a tree, a path, a walkway, a deck, a pool, and a campsite to prevent an insect from sensing or approaching the target.

13. The method of claim 1, wherein the insect is selected from the group consisting of paper wasps, yellowjackets, and hornets, or any combination thereof.

14. The method of claim 13, wherein the insect is selected from the group consisting of Polistes annularis; P. apaches; P. aurifer (Golden Paper Wasp); P. bellicosus; P. carolina; P. dominula (European Paper Wasp); P. dorsalis; P. exclamans; P. fuscatus; P. metricus; P. perplexus); Vespula acadica Sladen; V. atropilosa Sladen (Prairie Yellowjacket); V. austriaca Panzer; V. consobrina Saussure (Blackjacket); V. flavopilosa Jakobson (Transition Yellowjacket); V. germanica Fabricius (German Yellowjacket); V. maculifrons Buysson (Eastern Yellowjacket); V. pensylvanica Saussure (Western Yellowjacket); V. squamosa Drury (Southern Yellowjacket); V. sulphurea Saussure (California Yellowjacket); V. vidua Saussure (Forest Yellowjacket); V. vulgaris Linnaeus (Common Yellowjacket); Dolichovespula arenaria Fabricius (Aerial Yellowjackets); D. maculata Linnaeus (Bald-faced Hornet); D. norvegicoides Sladen (Arctic Yellowjacket); Vespa crabro Linnaeus (European Hornet); V. mandarinia Smith (Asian Giant Hornet); and V. orientalis Linnaeus (Oriental Hornet).

15. A method for repelling insects, comprising:
releasing into a space a repellent composition comprising at least one synthetic compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof;
wherein the repellent composition is comprised in a controlled release device having at least one aperture configured to achieve a desired rate of release of the repellent composition in a volatilized state into the space; and
repelling from the space an insect belonging to the insect family Vespidae, wherein each synthetic compound acts to repel the insect.

16. The method of claim 15, wherein the repellent composition further comprises at least one of (a) or (b):
(a) a first essential oil selected from the group consisting of lemongrass oil, ylang ylang oil, clove oil, geranium oil, rosemary oil, spearmint oil, wintergreen oil, lavender oil, sage oil, anise oil, fennel oil, citronella oil, peppermint oil, pennyroyal oil, thyme oil, Roman chamomile oil, and patchouli oil, or any combination thereof;
(b) a second essential oil comprising at least one compound selected from the group consisting of I-menthone, P-menthone, eugenol, E-citral, Z-citral, pulegone, α/β-thujones, methyl benzoate, d-carvone, methyl salicylate, E/Z-nepetalactone, Z/E-nepetalactone, 3-octanol, benzyl acetate, citronellal, an isomer thereof, or any combination thereof, wherein the compound is a major constituent of the second essential oil.

17. The method of claim 16, wherein the repellent composition comprises two or more first essential oils of (a).

18. The method of claim 16, wherein the repellent composition comprises two or more second essential oils of (b).

19. The method of claim 16, wherein the repellent composition comprises at least one first essential oil of (a) and at least one second essential oil of (b).

20. The method of claim 15, wherein the controlled release device comprises a polymeric sheet having a means for permitting the repellent composition in a volatilized state to pass therethrough.

21. The method of claim 20, wherein the polymeric sheet comprises a plurality of laminae.

22. The method of claim 21, wherein an innermost lamina of the plurality of lamina is semi-permeable such that the repellent composition in a volatilized state can pass through the innermost lamina.

23. The method of claim 20, wherein the means for permitting the repellent composition to pass therethrough comprises a plurality of micro-perforations.

24. The method of claim 23, wherein the polymeric sheet further comprises an innermost lamina and wherein at least some of the plurality of micro-perforations do not penetrate an innermost lamina of the polymeric sheet.

25. The method of claim 15, further comprising placing the controlled release device outdoors.

26. The method of claim 25, wherein the controlled release device is placed on or with 10 feet of a target selected from the group consisting of the eaves of a residential building, a commercial building, a fence, a picnic table, a barbeque site, a garbage bin or area, a playground, a recreation park, a tree, a path, a walkway, a deck, a pool, and a campsite to prevent an insect from sensing or approaching the target.

27. The method of claim 15, wherein the insect is selected from the group consisting of paper wasps, yellowjackets, and hornets, or any combination thereof.

28. The method of claim 27, wherein the insect is selected from the group consisting of Polistes annularis; P. apaches; P. aurifer (Golden Paper Wasp); P. bellicosus; P. carolina; P. dominula (European Paper Wasp); P. dorsalis; P. exclamans; P. fuscatus; P. metricus; P. perplexus); Vespula acadica Sladen; V. atropilosa Sladen (Prairie Yellowjacket); V. austriaca Panzer; V. consobrina Saussure (Blackjacket); V. flavopilosa Jakobson (Transition Yellowjacket); V. germanica Fabricius (German Yellowjacket); V. maculifrons Buysson (Eastern Yellowjacket); V. pensylvanica Saussure (Western Yellowjacket); V. squamosa Drury (Southern Yellowjacket); V. sulphurea Saussure (California Yellowjacket); V. vidua Saussure (Forest Yellowjacket); V. vulgaris Linnaeus (Common Yellowjacket); Dolichovespula arenaria Fabricius (Aerial Yellowjackets); D. maculata Linnaeus (Bald-faced Hornet); D. norvegicoides Sladen (Arctic Yellowjacket); Vespa crabro Linnaeus (European Hornet); V. mandarinia Smith (Asian Giant Hornet); and V. orientalis Linnaeus (Oriental Hornet).
